(19) United States
(12) Patent Application Publication
(10) Pub. No.: US 2018/0305204 A1
(43) Pub. Date: Oct. 25, 2018

(54) BORON NANOPARTICLE COMPOSITIONS AND METHODS FOR MAKING AND USING THE SAME

(71) Applicant: The Research Foundation for The State University of New York, Buffalo, NY (US)

(72) Inventors: Parham ROHANI, Amherst, NY (US); Mark SWIHART, Williamsville, NY (US)

(21) Appl. No.: 15/765,887

(22) PCT Filed: Oct. 6, 2016
(86) PCT No.: PCT/US2016/055757

§ 371 Date: Apr. 4, 2018

Related U.S. Application Data
(60) Provisional application No. 62/238,030, filed on Oct. 6, 2015.

(51) Int. Cl. C01B 3/06; C01B 3/08; C01B 35/02

(52) U.S. Cl. CPC C01B 3/065; C01B 3/08; C01B 35/023; C01B 2203/1223; B82Y 40/00; C01B 2203/1614; C01B 2203/1628; C01P 2004/64; C01B 2203/1229

(57) ABSTRACT

Provided are boron nanoparticles. The boron nanoparticles can be made by pyrolysis of a boron precursor (e.g., a boron hydride such as, for example, diborane) using a photosensitizer and electromagnetic radiation of an appropriate wavelength. The boron nanoparticles can be functionalized. The boron nanoparticles can be hydrogen-containing boron nanoparticles (e.g., hydrogen-terminated boron nanoparticles). Also provided are methods of hydrogen generation using boron nanoparticles, an activator, and water. Examples of activators include, but are not limited to, Li, Na, K, LiH, NaH, and combinations thereof.

### CROSS REFERENCE TO RELATED APPLICATIONS

This application claims priority to U.S. Provisional Application No. 62/238,030, filed on Oct. 6, 2015, the disclosure of which is hereby incorporated by reference.

### FIELD OF THE DISCLOSURE

This disclosure relates generally to the fields of boron nanomaterials and hydrogen generation.

### BACKGROUND

Boron and its compounds have attracted extensive attention due to their structural complexities, unique properties, and wide range of existing and potential applications. With respect to mechanical properties, boron is a hard and lightweight material with thermo-stabilizing capabilities, and is a component of boron nitride and other ultra-hard materials. In microelectronics, boron is widely used as a p-type dopant in silicon, as well as in superconducting devices and neutron detectors. The chemical properties of boron make it useful as a high-energy component in solid fuels and propellants. Its energy density (gravimetric heat of combustion) of 59 kJ/g, is substantially higher than those of conventional liquid hydrocarbon fuels like gasoline and diesel (˜46 kJ/g) and other solid energetic materials, including aluminum (31.0 kJ/g). In medicine, boron neutron capture therapy (BNCT), a noninvasive cancer treatment using boron-10, is another important application. Furthermore, boron has the highest gravimetric hydrogen production potential among inorganic solids that can be used for chemical splitting of water, up to 277 g Hz/kg B. For comparison, silicon, aluminum, and sodium hydride have gravimetric hydrogen production potentials of 142, 111, and 98 g Hz/kg, respectively.

Hydrogen is an emission-free fuel with high gravimetric energy content (120 kJ/g) that can be used efficiently in well-developed polymer electrolyte membrane (PEM) fuel cells. Hydrogen generation and storage has attracted considerable attention in the past few years because of practical limitations of conventional gas storage methods, such as high-pressure tanks, for hydrogen.

On-demand generation of hydrogen from water is one means of providing hydrogen for fuel cells and other uses. The direct thermolysis of water into hydrogen and oxygen requires temperatures above 2500 K and is therefore impractical in most applications. Chemical water splitting, by reacting water with a metal to produce a metal oxide and release hydrogen, is an attractive means of splitting water at much lower temperature. However, the reaction rate of metal hydrolysis usually decreases with time because of oxide formation at the surface of the metal particles. Thermodynamically, boron has great potential for on-demand hydrogen generation by reaction with water. However, boron is generally unreactive with water; it requires either a catalyst or very high temperature to react. Kinetics of heterogeneous, non-catalytic hydrolysis of boron (micron sized, ˜44 μm) were investigated over a range of temperatures and steam concentrations, demonstrating increased reaction rate with increasing temperature (from 500 to 800° C.). In another study, amorphous boron hydrolysis at somewhat lower temperatures (below 600° C.) in an oxygen free environment was investigated. Both studies reported that the boron hydrolysis reaction is first order with respect to boron and happens in two stages. The first stage is a gas-solid reaction, which is fast and exothermic. Boron is oxidized by steam and forms an ash layer (boron oxide) on its surface. In the second stage, boron oxide gasifies as it forms, producing volatile compounds (e.g. boric acid), exposing the remaining boron in the core to the steam. Because the oxide layer has low permeability, the rate-limiting step is the diffusion of steam through the oxide layer, which depends on the steam temperature. To date, all published boron hydrolysis studies have used steam at temperatures of at least 500° C., which makes the process complex and expensive.

There is an ongoing and unmet need for materials that enable hydrolysis without the use of external heating.

### SUMMARY OF THE DISCLOSURE

The present disclosure provides boron nanoparticles, compositions comprising the boron nanoparticles and methods for making and using the nanoparticles and compositions. For example, the boron nanoparticles can be used in methods of hydrogen generation under ambient temperatures (e.g., room temperature), with exogenous/external heating of the reaction mixture (e.g., comprising one or more types of boron nanoparticles, activator(s), water) used to generate hydrogen.

In an aspect, the present disclosure provides a process for producing boron nanoparticles. The methods are based on pyrolysis of a boron precursor. In an example, a process for producing boron nanoparticles comprises laser pyrolysis of a boron precursor in the presence of a photosensitizer and a sheath gas under conditions effective to produce boron nanoparticles in a reactor. In an example, the laser pyrolysis utilizes an infrared laser. In an example, the infrared laser is a CO₂ laser.

In an aspect, the present disclosure provides boron nanoparticles. For example, the boron nanoparticles can be made by a method described herein. In an example, the boron nanoparticles have an average primary (non-aggregated) particle size (e.g., diameter) of from about 10 nm to about 15 nm and all values therebetween. In an example, the boron nanoparticles contain less than 5%, 4%, 3%, 2%, 1%, 0.5%, or 0.1% of elements other than boron and hydrogen. In various examples, at least 80%, 85%, 90%, 95%, 96%, 97%, 98%, and 99% of the boron nanoparticles produced by the process of the present disclosure have an average primary particle size of between from about 10 nm to about 15 nm in diameter. The boron nanoparticles can comprise hydrogen (hydrogen-containing boron nanoparticles or hydrogenated boron nanoparticles). The hydrogen can be dissolved in the boron nanoparticles and/or disposed on at least a portion of the surface of the nanoparticles. The boron nanoparticles can be hydrogen-terminated boron nanoparticles. In an example, the boron nanoparticles are functionalized. In another aspect, the boron nanoparticles are not functionalized.

In an example, the present disclosure provides a composition comprising a plurality of boron nanoparticles. The boron nanoparticles of the present disclosure may be dispersed in a solvent, wherein the solvent is selected from water and various alcohols. The solvent can comprise water and one or more alcohols.

In an aspect, the present disclosure provides a method for generating hydrogen. The methods can use boron nanoparticles of the present disclosure. For example, a method of generating hydrogen comprises a nanoparticle (e.g., a boron nanoparticle) and a liquid (e.g., a liquid comprising water or water), where upon addition of an activator, hydrogen is generated. Hydrogen reaction occurs from reaction of the nanoparticles (e.g., boron nanoparticles). The methods can be carried out without use of an exogenous or external heat source (e.g., no additional energy is added to the system).

In an aspect, the present disclosure provides uses of the boron nanoparticles of the present disclosure. For example, a device (e.g., a hydrogen-generating device) comprises boron nanoparticles. A hydrogen-generating device can be used to supply hydrogen to another device that uses hydrogen (e.g., a fuel cell or instrument such as, for example, a chromatography instrument or spectrometer).

### BRIEF DESCRIPTION OF THE FIGURES

For a fuller understanding of the nature and objects of the disclosure, reference should be made to the following detailed description taken in conjunction with the accompanying figures.

FIG. 1 shows a schematic representation of a laser-driven aerosol reactor of the present disclosure.

FIG. 2 shows a schematic of the six-way cross CO₂ laser pyrolysis reactor with a cut-away to show the intersection of the laser beam and reactant gas stream, where particle formation occurs. The inset is a photograph of the reaction zone in the reactor.

FIG. 3 shows representative TEM images of boron nanoparticles (BNPs) at varying magnification (a-c). A powder XRD pattern from the BNPs using an air tight sample holder is shown in (d). The inset is the background-subtracted XRD pattern. FTIR spectrum of the BNPs is shown in (e). A photograph of BNP dispersions in various solvents after long-term storage at ambient conditions is shown in (f).

FIG. 4 shows (a) powder XRD of air exposed BNPs immediately after exposure to the atmosphere and after 20 h (h=hour(s)) and 10 days of exposure. (b) TGA of the as synthesized and air exposed BNPs with 10 K/min heating rate, under 50% O₂-50% Ar (v/v) carrier gas. The inset is the derivative thermogravimetric curve for the as synthesized BNPs. (c-f) XPS analysis of B is core levels for as synthesized, 1 hour, 1 month and 4 month air exposed BNPs, respectively

FIG. 5 shows (a) hydrogen production by BNP hydrolysis using 1 mmol NaH, K, Na or Li as an activator. (b) Hydrogen production from BNP hydrolysis using 0.5, 1 and 2 mmol NaH as an activator. (c) Comparison of BNP hydrolysis of as synthesized and 1 hour air exposed particles with 1 mmol NaH as an activator. (d) TEM image of the solid product of hydrogen generation experiments. Dashed lines in (a) and (b) are provided to aid visualization of the trends.

FIG. 6 shows mass spectra of the gaseous product of BNP hydrolysis activated by NaH using D₂O and H₂O respectively (a-b). The insets are the backgrounds of the analysis, which have been subtracted to produce the main plots. Plots of voltage and current measurements collected from a TDM 20 stack fuel cell using hydrogen generated by boron hydrolysis (mixtures of BNPs and NaH) compared to results using hydrogen from a compressed gas cylinder are shown in (c-d).

FIG. 7 shows size distribution of aggregates obtained using Nanosight nanoparticle tracking analysis.

FIG. 8 shows EDX analysis of as synthesized BNPs.

FIG. 9 shows UV-Vis spectrum of BNPs dispersed in ethanol.

FIG. 10 shows (a) TGA of the BNPs with different heating rates, and (b) derivative thermogravimetric curve of part (a).

FIG. 11 shows TGA of as synthesized BNPs with 10 K/min heating rate under UHP He and Nz.

FIG. 12 shows TGA-DTG of BNPs and a commercial boron with 10 K/min heating rate under 50% O₂-50% Ar.

FIG. 13 shows TEM images of a commercial boron (a-c) and SAED of commercial boron (d).

FIG. 14 shows powder XRD pattern of a commercial boron.

FIG. 15 shows XPS analysis of B is core level for commercial boron. The peak near 186.9 eV is from elemental boron. The peaks near 188.1 and 188.6 eV are representative of boron suboxides. The peak near 192.2 eV is from the B³⁺ oxidation state.

FIG. 16 shows hydrogen generation versus time for 32 mg BNPs mixed with 1 mmol NaH, K, Na, Li, MgH₂, or LiH hydrolyzed by 2 mL water.

FIG. 17 shows hydrogen generation from 2 mL water using 2 mmol NaBH₄ and different amounts of boron nanoparticles.

FIG. 18 shows gravimetric hydrogen generation from 2 mL water using 2 mmol NaBH₄ and different amounts of boron nanoparticles.

FIG. 19 shows XPS survey spectra of BNPs after and before hydrogen generation reactions.

### DETAILED DESCRIPTION

Although claimed subject matter will be described in terms of certain embodiments and examples, other embodiments and examples, including embodiments and examples that do not provide all of the benefits and features set forth herein, are also within the scope of this disclosure. Various structural, logical, process step, and electronic changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

It is an object of the present disclosure to provide boron nanoparticles, compositions comprising the inventive boron nanoparticles and methods for making and using the nanoparticles and compositions.

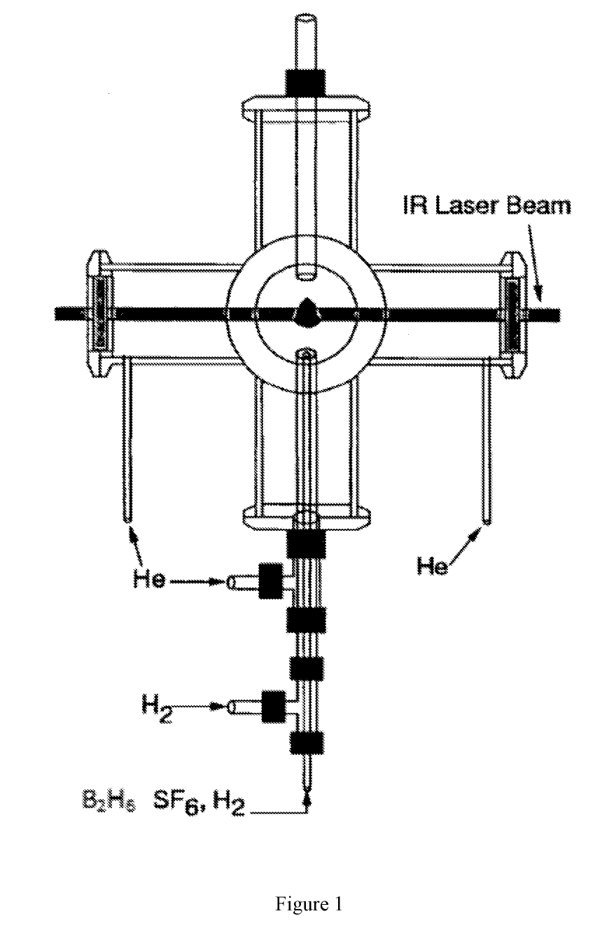

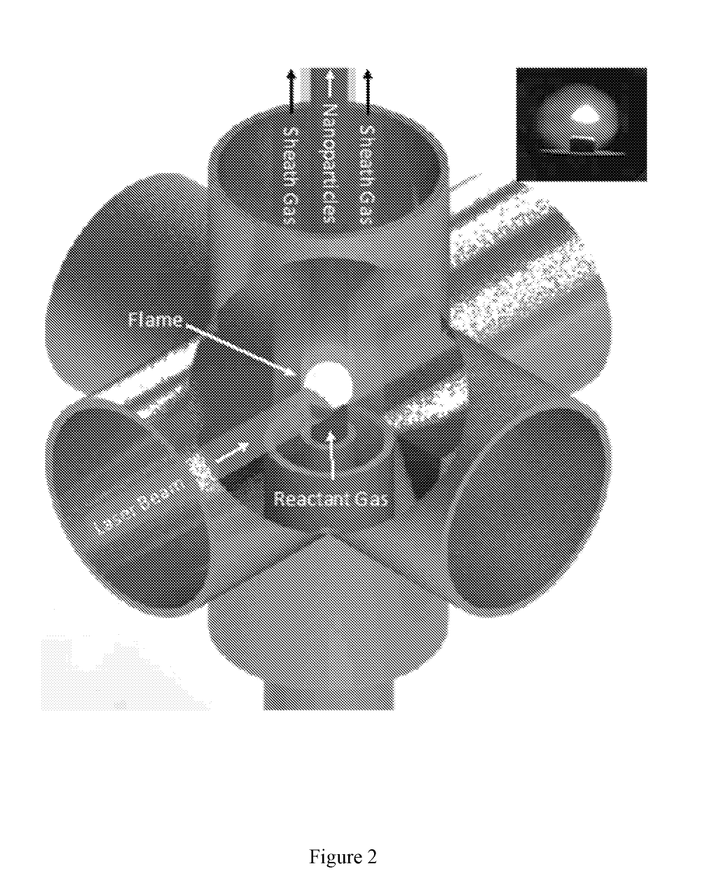

In an aspect, the present disclosure provides a process for producing boron nanoparticles. The methods are based on pyrolysis of a boron precursor. For example, boron nanoparticles can be made using reactors such as those shown in FIGS. 1 and 2.

In an example, a process for producing boron nanoparticles comprises laser pyrolysis of a boron precursor in the presence of a photosensitizer and a sheath gas under conditions effective to produce boron nanoparticles in a reactor. In an example, the laser pyrolysis utilizes an infrared laser. In an example, the infrared laser is a CO₂ laser.

Various photosensitizers can be used. It is desirable that the photosensitizers are thermally stable. The photosensitizer absorbs at least a portion of the electromagnetic radiation that irradiates the mixture comprising boron precursor and photosensitizer. In an example, the photosensitizer is sulfur hexafluoride (SF₆) and the infrared laser is used at a wavelength of 10.6 microns. In an example, the photosensitizer is silicon tetrafluoride (SiF₄) and the laser is used at a wavelength of 9.6 microns. A different wavelength could also be used with the appropriate photosensitizer that would absorb at that wavelength. For example, a diode laser operating near 1 micron wavelength could be used for the laser pyrolysis.

Various boron precursors can be used. The boron precursor is in the gas phase under the reaction conditions. Examples of boron precursors include, but are not limited to, boron hydrides and boron halides such as, for example, boron chlorides). In an example, the boron precursor a boron halide such as, for example, diborane, triborane, and higher boranes. In an example, the boron precursor is not decarborane.

The boron precursor can be present in hydrogen. In an example, the diborane is present in a mixture with hydrogen, such as ultrahigh-purity (UPH) hydrogen. In another example, the diborane is present in a concentration of about 5% in hydrogen, such as UHP hydrogen.

For example, the sheath gas enters the reactor through an inlet surrounding the inlet for the boron precursor. As such, the sheath gas forms a sheath that confines the precursor and photosensitizer gases. In an example, the sheath gas is hydrogen, such as UHP hydrogen.

The process can be run under various pressure conditions. For example, the reaction is run at about 1 atmosphere. In an example, the pressure within the reactor is maintained between 7.75 psi and 8.1 psi. Without intending to be bound by any particular theory it is considered that pressure can effect particle size.

In an example, the boron precursor and photosensitizer have a residence time in the laser beam of about 0.1 millisecond to about 1 second and all values therebetween. In another aspect, the boron precursor and photosensitizer have a residence time in the laser beam of about 1 millisecond to about 0.1 second and all values therebetween. In another aspect, the boron precursor and photosensitizer have a residence time in the laser beam of about 1 millisecond to about 0.01 second and all values therebetween. In another aspect, the boron precursor and photosensitizer have a residence time in the laser beam of about 1 millisecond to about 7 milliseconds and all values therebetween. In another aspect, the boron precursor and photosensitizer have a residence time in the laser beam of about 1 millisecond to about 5 milliseconds and all values therebetween. In another aspect, the boron precursor and photosensitizer have a residence time in the laser beam of about 1 millisecond to about 3 milliseconds and all values therebetween.

In an example, the process further comprises a step of purging the reaction vessel in which the reactants are reacted (e.g., a reactor) with a purge gas, such as helium.

The rate of production of boron nanoparticles of the present disclosure may be increased by, for example, increasing one or more of the following: the flow rate of the boron precursor (gas) through the reactor and the laser power.

The process may further comprise the step of collecting the boron nanoparticles. The boron nanoparticles produced by the process of the present disclosure may be collected on a filter, such as, for example, a cellulose nitrate membrane filter or a glass or cellulose fiber filter, according to known procedures. Particles might also be collected, for example, by thermophoretic deposition onto a cooled surface or by electrophoretic deposition onto an electrically charged surface. They might also be collected directly into a liquid solution by bubbling the reactor effluent through the solution, or through two or more bubblers of solution in series.

In an aspect, the present disclosure provides boron nanoparticles. For example, the boron nanoparticles can be made by a method described herein. Accordingly, in an example, the boron nanoparticles are made by a method of the present disclosure.

In an example, the boron nanoparticles of the present disclosure possess a spherical morphology.

In an example, the boron nanoparticles have an average primary (non-aggregated) particle size (e.g., diameter) of from about 10 nm to about 15 nm and all values therebetween. In another example, the boron nanoparticles have an average primary particle size from about 1 nm to 9 nm and all values therebetween. In a further aspect, the boron nanoparticles have an average primary particle size from about 1 nm to about 7 nm and all values therebetween. In still another example, the boron nanoparticles have an average primary particle size from about 1 nm to about 5 nm and all values therebetween.

In an example, the boron nanoparticles contain less than 5%, 4%, 3%, 2%, 1%, 0.5%, or 0.1% of elements other than boron and hydrogen.

In various examples, at least 80%, 85%, 90%, 95%, 96%, 97%, 98%, and 99% of the boron nanoparticles produced by the process of the present disclosure have an average primary (non-aggregated) particle size (e.g., diameter) of between from about 10 nm to about 15 nm in diameter. In various examples, at least 80%, 85%, 90%, 95%, 96%, 97%, 98%, and 99% of the boron nanoparticles produced by the process of the present disclosure have an average primary (non-aggregated) particle size (e.g., diameter) of about 10 nm to about 15 nm in diameter. In various examples, at least 80%, 85%, 90%, 95%, 96%, 97%, 98%, and 99% of the boron nanoparticles produced by the process of the present disclosure have an average primary particle size of from about 1 nm to 9 nm, including all 0.1 nm values therebetween. In various examples, at least 80%, 85%, 90%, 95%, 96%, 97%, 98%, and 99% of the boron nanoparticles produced by the process of the present disclosure have an average primary particle size of from about 1 nm to about 7 nm, including all 0.1 nm values therebetween. In various examples, at least 80%, 85%, 90%, 95%, 96%, 97%, 98%, and 99% of the boron nanoparticles produced by the process of the present disclosure have an average primary particle size of from about 1 nm to about 5 nm, including all 0.1 nm values therebetween.

The boron nanoparticles can comprise hydrogen (hydrogen-containing boron nanoparticles or hydrogenated boron nanoparticles). The hydrogen can be dissolved in the boron nanoparticles and/or disposed on at least a portion of the surface of the nanoparticles. The boron nanoparticles can be hydrogen-terminated boron nanoparticles.

In an example, the boron nanoparticles comprise hydrogenated boron nanoparticles possessing an average primary (non-aggregated) particle size (e.g., diameter) from about 10 nm to about 15 nm, including all 0.1 nm values therebetween. In another example, the boron nanoparticles comprise hydrogenated boron nanoparticles possessing an average primary particle size from about 1 nm to 9 nm, including all 0.1 nm values therebetween. In a further example, the boron nanoparticles comprise hydrogenated boron nanoparticles possessing an average primary particle size from about 1 nm to about 7 nm, including all 0.1 nm values therebetween. In yet another example, the boron nanoparticles comprise hydrogenated boron nanoparticles possessing an average primary particle size from about 1 nm to about 7 nm and all values therebetween.

By “about” with respect to particle size herein it is meant that the values include particle size measurement variance. Particle size can be measured by methods known in the art (e.g., spectroscopy methods such as, for example, transmission electron spectroscopy and surface area measurement). Particle size can be measured by methods disclosed herein.

In an example, the boron nanoparticles are functionalized. In another aspect, the boron nanoparticles are not functionalized.

The boron nanoparticles (e.g., boron nanoparticles made by a method of the present disclosure can exhibit desirable stability. For example, the boron nanoparticles exhibit less boron oxide and/or boron suboxides than boron made by methods previously known in the art (e.g., a commercially available boron such as, for example, a commercially available boron disclosed herein) after being exposed to air (e.g., after 4 months of more air exposure).

In an example, the present disclosure provides a composition comprising a plurality of boron nanoparticles.

The boron nanoparticles of the present disclosure may be dispersed in a solvent, wherein the solvent is selected from water and various alcohols, such as methanol, ethanol, isopropyl alcohol, propanol, butanol, pentanol, hexanol, and diols and polyols. Suitable diols and polyols include ethylene glycol, propylene glycol and 1,4-butanediol.

In an aspect, the present disclosure provides a method for generating hydrogen. The methods can use boron nanoparticles of the present disclosure. For example, a method of generating hydrogen comprises a nanoparticle (e.g., a boron nanoparticle) and a liquid (e.g., comprising water or water), where upon addition of an activator, hydrogen is generated. Hydrogen reaction occurs from reaction of the nanoparticles (e.g., boron nanoparticles). The methods can be carried out without use of an exogenous or external heat source (e.g., no additional energy is added to the system). Accordingly, in an example, hydrogen generation occurs in the absence of an exogenous heat source or external heat source.

In an example, a method for generating hydrogen comprises: (a) providing a mixture of nanoparticles (e.g., boron nanoparticles such as, for example, boron nanoparticles of the present disclosure), a liquid (e.g., a liquid comprising water or water), and an activator, and (b) allowing the boron nanoparticles, water and an activator to react under conditions effective to produce hydrogen.

The mixture of nanoparticles (e.g., boron nanoparticles such as, for example, boron nanoparticles of the present disclosure), liquid (e.g., liquid comprising water or water), and activator can be formed in various ways. The components can be mixed in any order. For example, boron nanoparticles and activator (e.g., solid boron nanoparticles and activator) are mixed dry and subsequent to the mixing the liquid is added. The mixture can be present in an inert atmosphere (e.g., in an inert gas such as nitrogen).

In an example, the nanoparticles are boron nanoparticles having an average primary (non-aggregated) particle size (e.g., longest dimension) of 1 to 15 nm, including all 0.1 nm values and ranges therebetween. In various examples, the boron nanoparticles contains less than 5%, 4%, 3%, 2%, 1%, 0.5%, 0.1%, or any integer therebetween of elements other than boron and hydrogen. In an example, the nanoparticles are hydrogen-containing boron nanoparticles (e.g., hydrogen-terminated boron nanoparticles). In an example, the nanoparticles hydrogen-containing boron nanoparticles (e.g., hydrogen-terminated boron nanoparticles) made by a method of the present disclosure. Mixtures of boron nanoparticles can be used.

Various amounts of nanoparticles (e.g., boron nanoparticles) can be used. Mixtures of nanoparticles can be used. For example, the nanoparticles (e.g., boron nanoparticles and/or hydrogen-containing boron nanoparticles) are present in a catalytic amount. The nanoparticles can be present as a loose powder. The nanoparticles and/or activator can be present as pellets.

Various liquids can be used in the liquid. In various examples, the liquid is selected from water, one or more alcohol (e.g., methanol, ethanol, isopropyl alcohol, propanol, butanol, pentanol, hexanol, ethylene glycol, propylene glycol, and 1,4-butanediol) and combinations thereof. In an example, the liquid is water. In another example, the liquid comprises water.

Various amounts of liquid can be used. In an example, the liquid comprises or is water and the amount of water is sufficient to wet the boron nanoparticles. In an example, the liquid comprises or is water and the amount of water is sufficient to wet the boron nanoparticles or greater. In another example, the liquid comprises water or is water and the ratio of boron nanoparticles to water (by molar ratio) is 5 or greater, with the proviso that there is enough water present to wet the boron nanoparticles.

The activator is at least partially or completely consumed in the hydrogen generation reaction. In various examples, the activator, which may be provided in catalytic quantities, is selected from the group consisting of alkali metals and metal hydrides. Suitable alkali metals include Li, Na, and K. Suitable metal hydrides include LiH and NaH. In various examples, the activator is an alkali metal, metal hydride, or a combination thereof. In various examples, the activator is selected from the group consisting of Li, Na, K, LiH, NaH, and combinations thereof. In an example, the activator is NaH. Mixtures of activators can be used.

Various amounts of nanoparticles and/or activators can be used. The activators can be present in the hydrogen generating mixture at 2 mol % or greater of the total amount of nanoparticles and activator(s). In an example, the nanoparticles (e.g., boron nanoparticles and/or hydrogen-containing boron nanoparticles) are present at 50 to 98 mol %, including all integer mol % values therebetween, and/or the activator(s) is/are present at 2 to 50 mol %, including all integer mol % values therebetween. In various examples, the nanoparticles (e.g., boron nanoparticles and/or hydrogen-containing boron nanoparticles) are present at 80 to 98 mol % and/or the activator(s) is/are present at 2 to 20 mol %, the nanoparticles are present at 90 to 98 mol % and/or the activator(s) is/are present at 2 to 10 mol %.

Various ratios of boron nanoparticles to activator can be used. For example, the ratio (molar ratio) of boron nanoparticles to activator (e.g., sodium hydride) is 50 or less.

Various ratios of liquid to boron nanoparticles can be used. For example, the liquid (e.g., water) to boron nanoparticles is 5 or greater.

The methods can be run under a variety of conditions. Effective conditions for the reactants to produce hydrogen include, for example, temperatures and pressures at which water is a liquid. For example, at atmospheric pressure, suitable temperatures would range from 0.01° to 99.6° Celsius (° C.), including all values therebetween. In various examples, the reaction is run at ambient pressure (e.g., 1 atmosphere) and room temperature (18° C. to 25° C.) to 50° C., room temperature to 70° C., room temperature to 99° C., or room temperature to 99.6° C.

Various amounts of hydrogen can be produced. In an example, less than a stoichiometric amount of hydrogen (based on the amount of nanoparticles and activators used) is produced. In an example, at least 0.1 mol of hydrogen is produced for mol of boron nanoparticles. In another example, at least 0.5 mol of hydrogen is produced for mol of boron nanoparticles.

The hydrogen product can comprise various isotopes of hydrogen and/or various ratios of hydrogen isotopes. For example, the hydrogen product comprises ¹H, ²H (deuterium), ³H (tritium), or a combination thereof.

In an aspect, the present disclosure provides uses of the boron nanoparticles of the present disclosure. For example, a device (e.g., a hydrogen-generating device) comprises boron nanoparticles.

For example, a hydrogen-generating device comprises boron nanoparticles (e.g., pelletized boron nanoparticles), water, and an activator. The device is configured such that the boron nanoparticles, water, and an activator can be combined and hydrogen generated. The device can be configured to selectively add of the boron nanoparticles, water, or an activator such that the fuel cell is an on-demand energy generating device. The device can comprise pelletized boron nanoparticles and/or pelletized activator, which may be packaged in, for example, a cartridge.

A hydrogen-generating device can be used to supply hydrogen to another device that uses hydrogen (e.g., a fuel cell or instrument such as, for example, a chromatography instrument or spectrometer). Accordingly, a fuel cell or instrument comprises a hydrogen-generating device described herein as a hydrogen source.

The steps of the method described in the various examples and examples disclosed herein are sufficient to carry out the methods of the present disclosure. Thus, in an example, a method consists essentially of a combination of steps of the methods disclosed herein. In another example, a method consists of such steps.

In the following Statements, various examples of the methods of the present disclosure are described:

Statement 1. A method of generating hydrogen gas comprising contacting one or more types of nanoparticles of the present disclosure (e.g., one or more types of boron nanoparticles of the present disclosure), a liquid comprising water (e.g., water), and one or more activators (e.g., alkali metals, metal hydrides, and combinations thereof) (which can be referred to as a hydrogen-generating mixture), where the hydrogen gas is generated.
Statement 2. A method of generating hydrogen gas according to Statement 1, wherein the activator is selected from the group consisting of lithium metal, sodium metal, potassium metal, lithium hydride, sodium hydride, and combinations thereof.
Statement 3. A method of generating hydrogen gas according to Statement 1 or Statement 2, where the activator is lithium hydride, sodium hydride, or a combination thereof
Statement 4. A method of generating hydrogen gas according to Statement 1 or Statement 2, where the activator is lithium metal, sodium metal, potassium metal, or a combination thereof
Statement 5. A method of generating hydrogen gas according to any one of the preceding Statements, where the nanoparticles are boron nanoparticles (e.g. hydrogen-containing boron nanoparticles).
Statement 6. A method of generating hydrogen gas according to Statement 5, where the boron nanoparticles contain less than 5% of elements other than boron and hydrogen.
Statement 7. A method of generating hydrogen gas according to any one of the preceding Statements, where the nanoparticles (e.g., boron nanoparticles or hydrogen-containing boron nanoparticles) have a size (e.g., diameter of a primary particle) of 1 to 15 nanometers (nm).
Statement 8. A method of generating hydrogen gas according to any one of the preceding Statements, where the liquid further comprises one or more additional liquids selected from the group consisting of methanol, ethanol, isopropyl alcohol, propanol, butanol, pentanol, hexanol, ethylene glycol, propylene glycol, and 1,4-butanediol.
Statement 9. A method of generating hydrogen gas according to any one of the preceding Statements, where hydrogen is generated at temperatures and pressures at which water is a liquid.
Statement 10. A method of making boron nanoparticles comprising irradiating a mixture of a boron precursor and photosensitizer (e.g., irradiating a boron precursor and photosensitizer in a sheath gas) with electromagnetic radiation comprising one or more wavelength that is absorbed by the photosensitizer such that the boron precursor is pyrolyzed and the boron nanoparticles are formed.
Statement 11. A method of making boron nanoparticles according to Statement 10, where the electromagnetic radiation is provided by an infrared laser.
Statement 12. A method of making boron nanoparticles according to Statements 10 or 11, wherein the electromagnetic radiation comprises a wavelength of 10.6 microns.
Statement 13. A method of making boron nanoparticles according to any one of Statements 10 to 12, where the photosensitizer is sulfur hexafluoride (SF₆).
Statement 14. A method of making boron nanoparticles according to any one of Statements 10 to 12, where the photosensitizer is silicon tetrafluoride (SiF₄).
Statement 15. A method of making boron nanoparticles according to any one of Statements 10 to 14, where the boron precursor is a boron-hydride precursor.
Statement 16. A method of making boron nanoparticles according to any one of Statements 10 to 15, where the boron-hydride precursor is diborane.
Statement 17. A method of making boron nanoparticles according to Statements 10 to 16, where the boron precursor is a boron-halide (e.g., a boron-chloride precursor).
Statement 18. A method of making boron nanoparticles according to any one of Statements 10 to 17, where the boron precursor is present in hydrogen gas.
Statement 19. A method of making boron nanoparticles according to any one of Statements 10 to 18, where the sheath gas is hydrogen.
Statement 20. A method of making boron nanoparticles according to any one of Statements 10 to 19, wherein the method further comprises collecting the boron nanoparticles.
Statement 21. A method of making boron nanoparticles according to any one of Statements 10 to 20, where the boron nanoparticles are collected on a filter.
Statement 22. A method of making boron nanoparticles according to any one of Statements 10 to 20, wherein the boron nanoparticles are collected by thermophoretic deposition.
Statement 23. A method of making boron nanoparticles according to any one of Statements 10 to 20, wherein the boron nanoparticles are collected in a liquid solution by contacting the irradiated mixture with the liquid.
Statement 24. A hydrogen-generating device comprising one or more types of nanoparticles (e.g., one or more types of boron nanoparticles of the present disclosure), one or more activators of the present disclosure, and water, where the device is configured such that the nanoparticles (e.g., boron nanoparticles), one or more activators, and water are combined and hydrogen is generated.
Statement 25. A hydrogen-generating device of Statement 24, where the nanoparticles (e.g., boron nanoparticles) and/or the one or more activator is/are disposed (e.g., contained) in a cartridge.

The following examples are presented to illustrate the present disclosure. They are not intended to limiting in any matter.

### Example 1

This example provides a description of methods of making and characterization boron nanoparticles and using boron nanoparticles to generate hydrogen.

Boron Nanoparticle Synthesis. CO₂ laser induced pyrolysis of reactant gases is a continuous and single step process to synthesize both pure and alloyed powder nanoparticles. We used CO₂ laser-induced pyrolysis of diborane to prepare BNPs at a rate of ˜210 mg/h. Production rate depended upon diborane concentration in the feed gas stream. FIG. 1 shows a schematic of the laser pyrolysis reactor. A continuous CO₂ laser beam (up to 100 W) was used to pyrolyze diborane at the center of a 6-way cross reactor. Under typical operating conditions, a stream containing 142 standard cubic centimeters per minute (sccm) of diborane gas mixture (5% diborane in UHP hydrogen, Voltaix LLC; 7.1 sccm diborane) and 5.3 sccm sulfur hexafluoride (SF₆, technical grade), as a photosensitizer. This gas stream entered the reactor through a central inlet positioned just below the laser beam. SF₆ absorbs the infrared energy of the laser beam and transfers it to diborane molecules by intermolecular collisions. A flow of 606 sccm of ultrahigh-purity (UHP) hydrogen, entered the reactor through a concentric annular inlet surrounding the diborane/SF₆ stream. This hydrogen serves as a sheath gas to confine the reacting gases, increase the nucleation temperature and decrease the particle growth rate. The sheath gas assists in obtaining rapid cooling of the particles when the leave the laser beam to obtain the small sizes produced. Because hydrogen is a by-product of diborane dissociation and particle formation it participates in the particle formation process; inert gases (e.g., helium, argon, and nitrogen) do not have the same effect on the process. The choice of inert gas for the sheath flow also affects the temperature in the reaction zone via the thermal conductivity and heat capacity of the gas. We estimate the temperature of the reaction zone to be between 1400 and 1600° C. The temperature cannot be measured directly, so this estimation is not intended to be a limitation on the process. Thermodynamically, formation of BNPs from diborane is very favorable at these temperatures (B₂H_{6(g)}→2B₍ₛ₎+3H_{2(g)}, K₁₄₀₀=1.03×10⁴⁹, K₁₆₀₀=9.70×10⁵⁴). To keep the IR-transparent ZnSe windows clean, 1890 sccm UHP helium flows into the reactor just below the windows. All gas flow rates are set and maintained using mass flow controllers. The unique design of our reactor enables synthesis of very small nanoparticles because of its very short residence time. The rapid heating by the laser and cooling by the unheated sheath gases occur in a few milliseconds. Thereafter, upon leaving the laser beam, the particles aggregate at a reduced temperature that does not allow further sintering into larger particles or hard agglomerates. The total pressure in the reactor was ˜8 psia (55 kPa). Product particles were collected on fibrous filters (Whatman® qualitative filter paper, Grade 1, cellulose filters, 11 μm nominal pore size) downstream of the reactor chamber. Most of the supplied diborane was converted to BNPs, with the yield of collected BNPs exceeding 50% of the theoretical yield. However, the unreacted gases pass through a furnace that decomposes any remaining diborane and then through nanoporous filters before sending the cleaned exhaust gas into the chemical exhaust system. A key advantage of diborane gas over other boron sources such as boron trichloride is that production of toxic and corrosive chlorine and hydrogen chloride byproducts is avoided. In addition, B—Cl bonds are more stable than B—H bonds (bond energies are 456 and 389 kJ/mol, respectively); hence, the temperature required to dissociate diborane molecules is lower. The reactor was purged three times with UHP helium before and after each run to make sure no oxygen was present in the system. After each run, particles were transferred in the sealed filter housing to an oxygen-free environment (nitrogen-filled glove box) for collection, characterization, and further use.

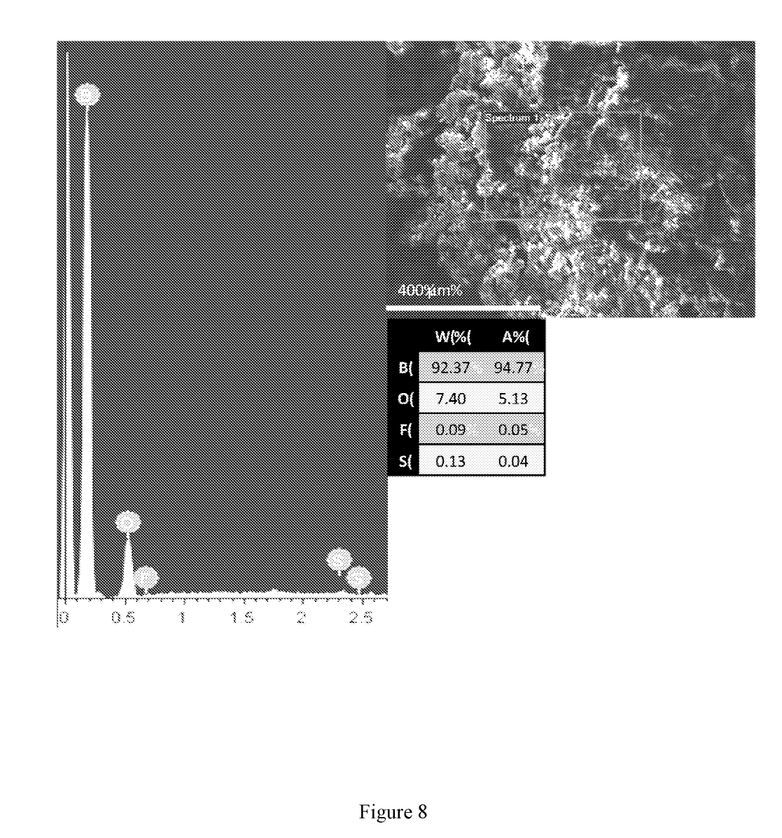

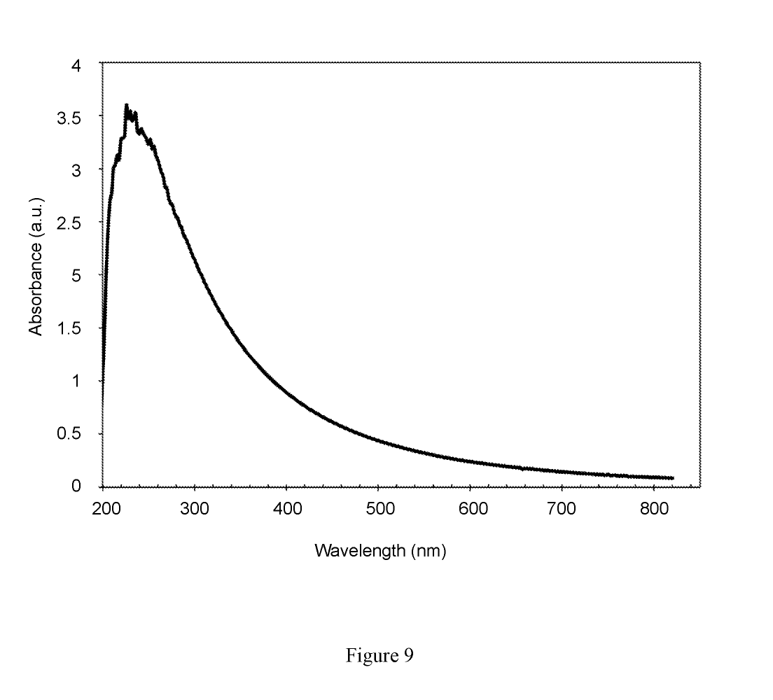

Boron Nanoparticle and Hydrolysis Product Characterization. BNPs were characterized by transmission electron microscopy (TEM), scanning electron microscopy (SEM), selected area electron diffraction (SAED), x-ray photoelectron spectroscopy (XPS), nanoparticle tracking analysis in solution, thermogravimetric analysis (TGA), Fourier transform infrared spectroscopy (FTIR), UV-vis absorbance spectroscopy, powder x-ray diffraction (XRD), and nitrogen physisorption (BET) surface area measurement. The gaseous products of boron-water (or boron-D₂O) reaction were characterized by mass spectrometry and by using them to power a PEM fuel cell. Further details of all characterization methods are provided herein. For example, FIG. 8 shows EDX analysis of as synthesized BNPs.

Boron Hydrolysis Experiments. Boron hydrolysis reactions are thermodynamically favorable, but do not occur at room temperature. Even decreasing the particle size to the nanoscale does not make boron water-reactive. Thus, we added potential activators, where hydrolysis of nanoparticles was catalyzed by alkali metal hydroxides. Alkali metal hydroxides can be generated in situ by reaction of alkali metals or alkali metal hydrides with water, which also generates additional hydrogen. To accelerate boron reactivity with water at room temperature, alkali metals and hydrides were used as potential activators. All the experiments were carried out in an inert atmosphere (N₂) in a custom-designed cylindrical vessel (˜50 mL internal volume). The BNPs and the activator were weighed in a glove box, added to the vessel, and connected to an inverted graduated cylinder of water to measure the volume of gas generated. Two mL of DI water (or deuterated water) was used in each experiment. In cases where we studied hydrolysis of air-exposed BNPs, we put the particles in a quartz tube and flowed dry air from a compressed gas cylinder over them at a rate of 10 standard liters per minute (slm). The exposed particles were then collected, weighed, and added to the hydrolysis cylinder. The cylinder was evacuated to remove air before returning it to the glovebox. Even when the particles had been air-exposed, the activator (NaH) was added within the glovebox and was not exposed to air.

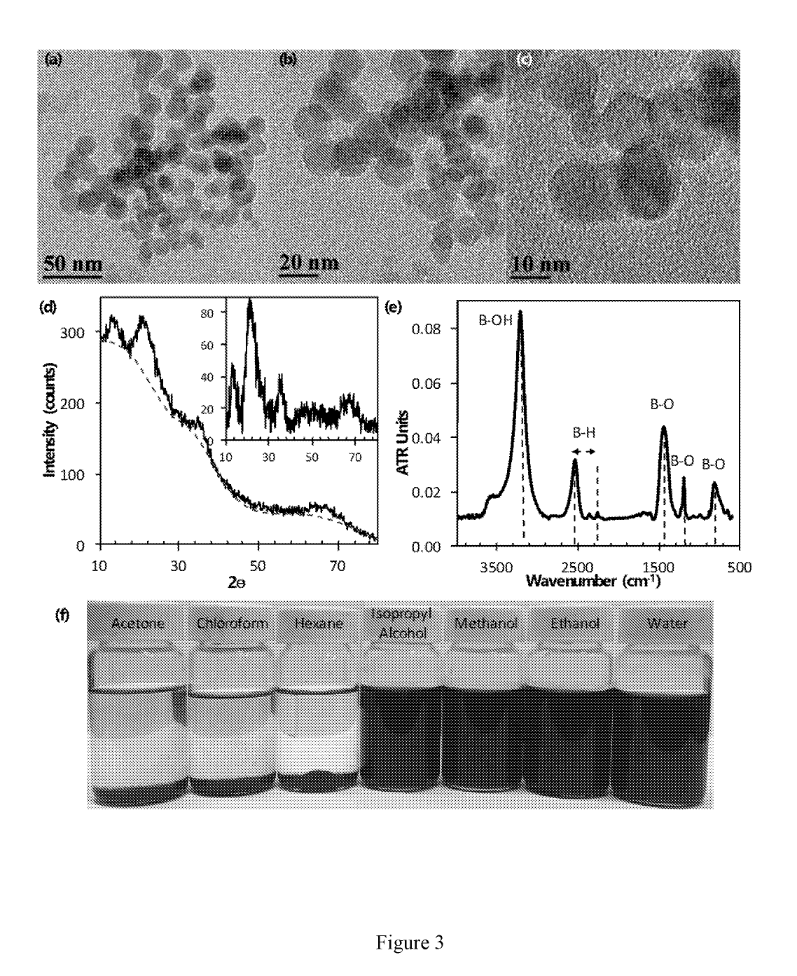

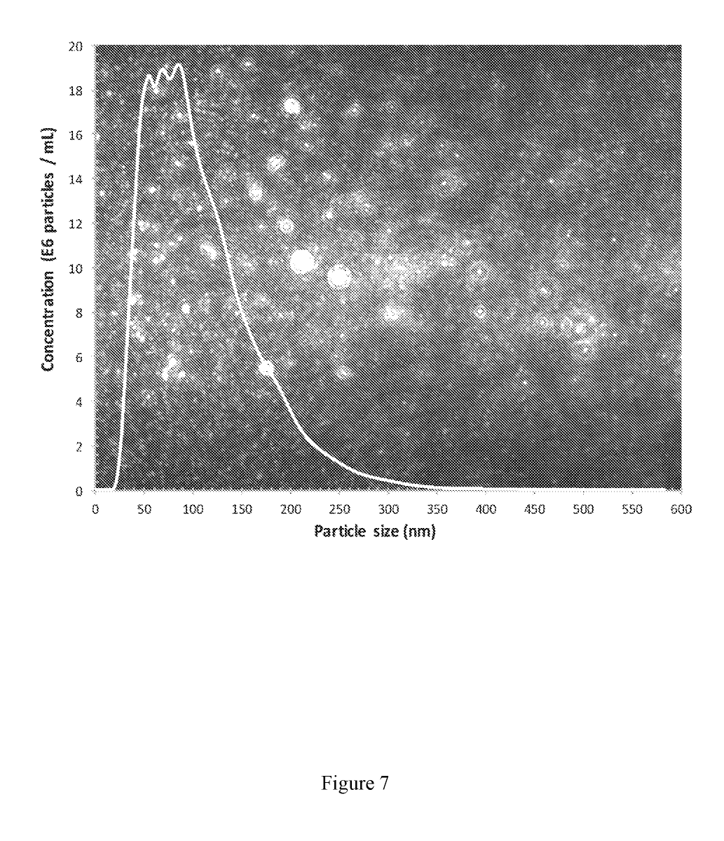

Boron Nanoparticle Characterization. The size and morphology of the BNPs were characterized by TEM imaging, as shown in FIG. 3(a-c). Based on these images, and other similar ones, the particles are spherical with a primary particle diameter of 10-15 nm. The primary particles are significantly aggregated, as expected for products of aerosol synthesis. Nanoparticle tracking analysis (NTA, NanoSight) was used to obtain the hydrodynamic diameter distribution of these aggregates. For a dilute dispersion of the BNPs in isopropyl alcohol prepared by 5 minutes of bath sonication, NTA gave a mean hydrodynamic diameter of 203 nm. After 3 hours of bath sonication of the same sample, the mean hydrodynamic diameter decreased to 108 nm. However, further sonication did not change the size of aggregates significantly. Further details are provided herein, in FIG. 7 and in Table 4. Using SEM and EDX elemental composition analysis, the purity of the BNPs was shown to be at least 92.4 weight percent B (FIG. 8). Small but detectable amounts of sulfur and fluorine in the particles are associated with decomposition of the SF₆ used as a photosensitizer in the laser pyrolysis synthesis. Powder x-ray diffraction of the BNPs employed an airtight N₂-filled sample holder. As shown in FIG. 3(d), the BNPs were amorphous. For the conditions at which the NPs form, ˜8 psi and ˜1600K, amorphous β-boron is the expected phase, so the amorphous nature of the NPs is not surprising. To investigate the surface chemistry of the NPs, FTIR spectra were collected, as shown in FIG. 3(e). The need to expose the particles to air is a drawback of this analysis because the BNPs can undergo rapid surface oxidation. FTIR shows peaks associated with B—H stretching near 2550-2280 cm⁻. An intense peak associated with B—OH stretching near 3220 cm⁻ and a shoulder associated with B—OH body stretching mode at near 3600 cm⁻ are also evident. Furthermore, three peaks near 1460, 1200 and 830 cm⁻ are associated with B—O stretching and deformation modes. The surface B—O and O—H bonds are attributed to immediate oxidation by oxygen and/or water vapor during sample preparation and analysis. However, B—H bonds may be formed during the synthesis process, during which hydrogen radicals can be produced by diborane dissociation. Molecular hydrogen is also present in the reactor in large excess relative to boron.

The BNPs could be stably dispersed in water and alcohols and remained well dispersed over time. FIG. 3(f) shows dispersions of BNPs in water, ethanol, methanol and isopropyl alcohol after several weeks of storage at ambient conditions. This stability in water and alcohols is consistent with the presence of hydroxyl groups on the NP surface after surface oxidation. The BNPs did not form stable colloids in solvents such as acetone, chloroform and hexane. BNPs aggregated and precipitated from those solvents within a few minutes. The specific surface areas of the BNPs and of commercially available amorphous boron particles (micron size) were measured by N₂ physisorption (BET method) without degassing. The BET surface areas were 255 and 25 m²/g for the BNPs and commercially available boron, respectively. Assuming the BNPs have the same density as bulk boron (2.34 g/cm³), this surface area gives an equivalent spherical diameter of 10 nm, which is in close agreement with the primary particle size observed in TEM images. The 10-fold higher surface area of BNPs compared to commercially available boron potentially allows the BNPs to be much more reactive in gas-surface processes.

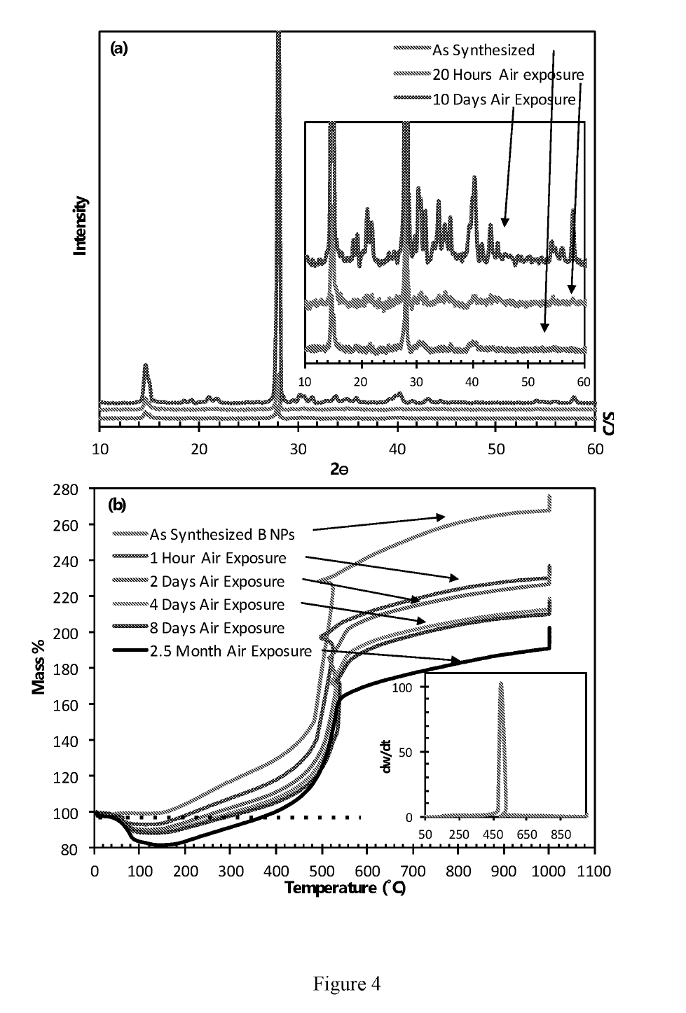

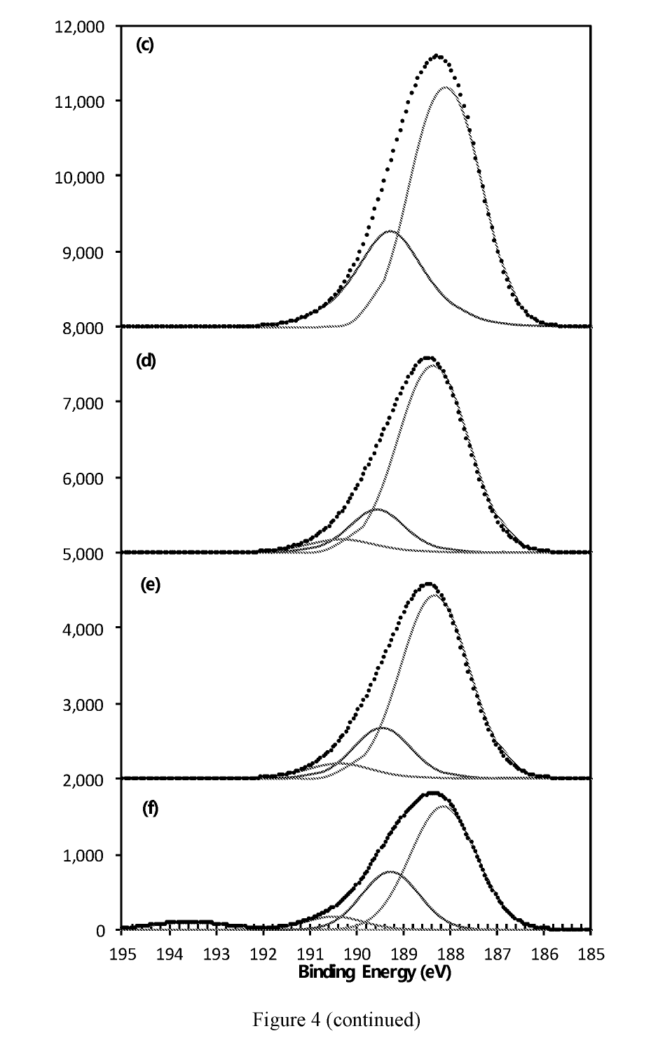

To investigate the oxidation of BNPs upon exposure to the atmosphere, we conducted powder XRD using a standard sample holder, immediately after the first analysis using an airtight sample holder. Upon air exposure, boron oxide peaks appeared immediately in the diffraction pattern. Further air exposure of the sample produced more intense peaks and also new peaks as shown in FIG. 4(a) for the same sample after 20 hours and 10 days of air exposure. The peaks are attributed to triclinic B(OH)₃, sassolite (PDF Card No.: 00-030-0199). Sassolite is a borate with a large number of boron-containing oxyanions, which can be considered a derivative of boric acid. Therefore, we can conclude that upon air exposure, the particles form a thin layer of sassolite. Further air exposure leads to diffusion of air through this layer and further oxidation. However, as the thickness of the oxide shell increases, the flux of oxygen decreases, limiting the oxidation.

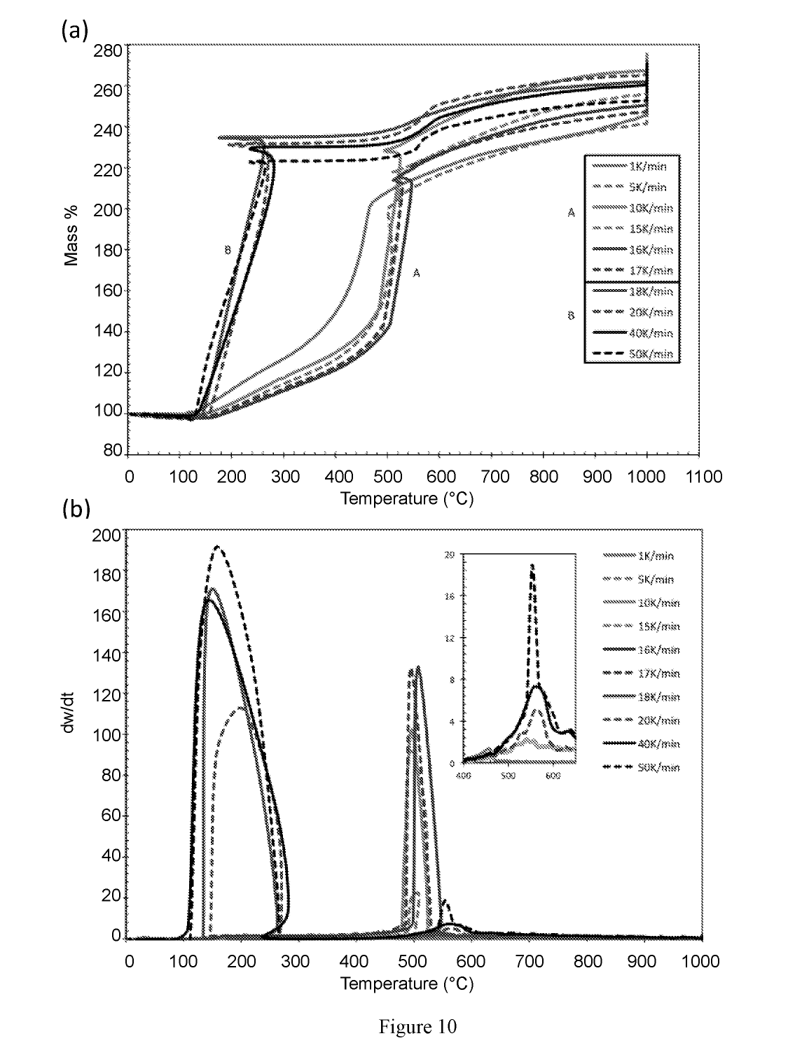

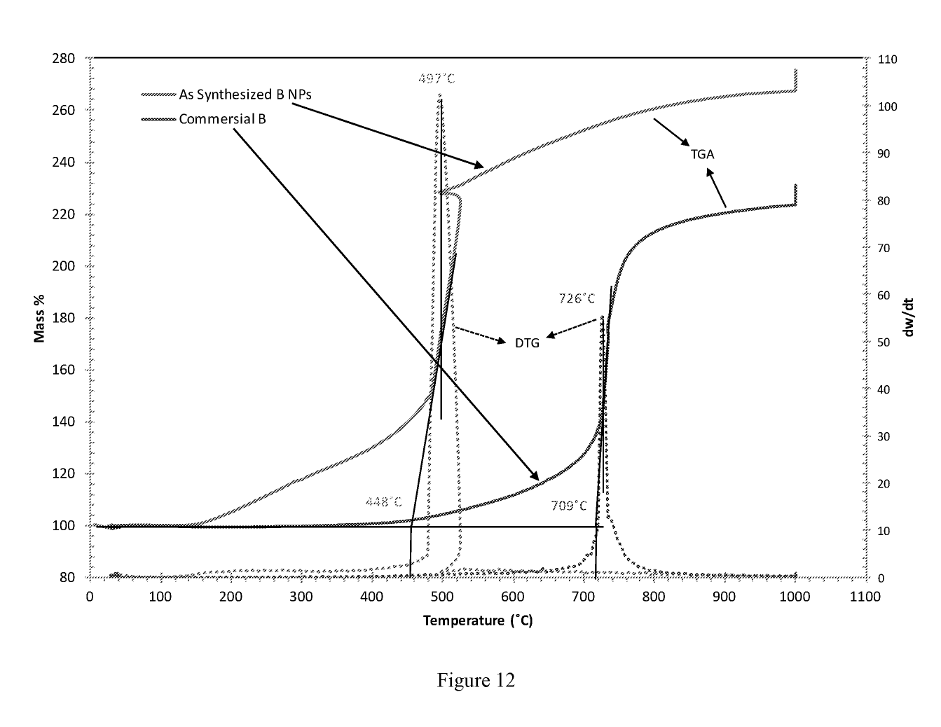

Thermogravimetric analysis (TGA) was conducted for the BNPs and air exposed BNPs using a mixture of 50% O₂-50% Ar (v/v), as shown in FIG. 4(b). Samples were heated from room temperature to 1000° C. at a heating rate of 10 K/min and then held at 1000° C. for an hour. Less air exposure time, prior to the TGA, led to more oxidation and more mass gain during TGA because more boron remained to be oxidized during TGA. A sharp mass gain was observed at 494° C. (near the melting point of B₂O₃) for the as prepared BNPs, as also shown in the derivative thermogravimetric curve in the inset of FIG. 3(b). The mass gain results from boron oxide formation. Below and above this temperature, the mass gain is much slower. Also, only ˜3% mass gain occurs in the isothermal section in an hour. Based on FIG. 3(b) for the BNPs, the TGA curve can be divided into three stages. In the first stage (room temperature to ˜150° C.), BNPs are non-reactive because of immediate formation of a thin layer of boron oxide/suboxide/hydroxide that prevents O₂ diffusion. In the second stage (˜150 to 497° C.), oxidation begins followed by a sharp mass gain when the boron oxide layer melts and the O₂ diffusion rate is dramatically accelerated. In the third stage (497 to 1000° C.), although mass gain continues, the rate of mass gain decreases because more boron oxide forms (presumably in liquid phase), which decreases O₂ diffusion. If we could continue to increase the temperature to around 1860° C., where boron oxide evaporates, there might be another jump in mass gain. The commercial boron sample behaved the same in TGA, but the three stages happened at different temperatures (room temperature to ˜400° C., 400-726° C. and 726-1000° C., see, e.g., FIG. 12). The theoretical mass gain for complete conversion of boron to boron oxide (322% for B+¾ O₂->½ B₂O₃) was not achieved in the temperature range of this study. For the as synthesized BNPs, the mass gain reached ˜267% at 1000° C. For BNPs that had been exposed to air for 2.5 months, the mass gain reached 191% at 1000° C., significantly less than the as synthesized BNPs, because some of the boron was converted to boron oxide before the analysis. Increasing the air exposure time leads to a slight increase of the onset temperature for rapid oxidation. Furthermore, from TGA of the as synthesized BNPs using different heating rates (FIG. 10) we can conclude that faster heating rates lead to sharper mass gain at much lower onset temperature of oxidation reaction. The oxidation process is very complex and detailed understanding of it would require an additional comprehensive study.

X-ray photoelectron spectra were collected with both low and high-resolution scans for the as synthesized and air exposed BNPs. Binding energies were referenced to the adventitious C1s peak at 284.8 eV. The XPS peaks were fitted to Gaussian-Lorentzian type functions and the area under each component was calculated. FIGS. 4(c-f) show the B 1s core level spectra for as synthesized, 1 hour, 1 month, and 4 month air exposed BNPs, respectively. According to the binding energies provided in Table 1, the BNPs have a large component at 188.0 eV associated with elemental boron)(B° and a small component at 189.2 eV associated with a suboxide. β-B has been reported to have a B is core level peak at 187.3±0.9 eV. However, there are other studies that reported the B 1s core level peak at 188.0 eV. The peak shift is attributed to surface charging and band bending. These conditions change the fermi level energy (total chemical potential of electrons) and hence, the valence band maximum. Ong et al. found that a polished and sputter-cleaned βᵣ-B sample has a B 1s peak at 187.9 eV and 0.7 eV fermi level energy, which gave a reference value of 187.2 eV. According to this reference value, we can conclude that our BNPs have a fermi level energy of ˜0.8 eV.

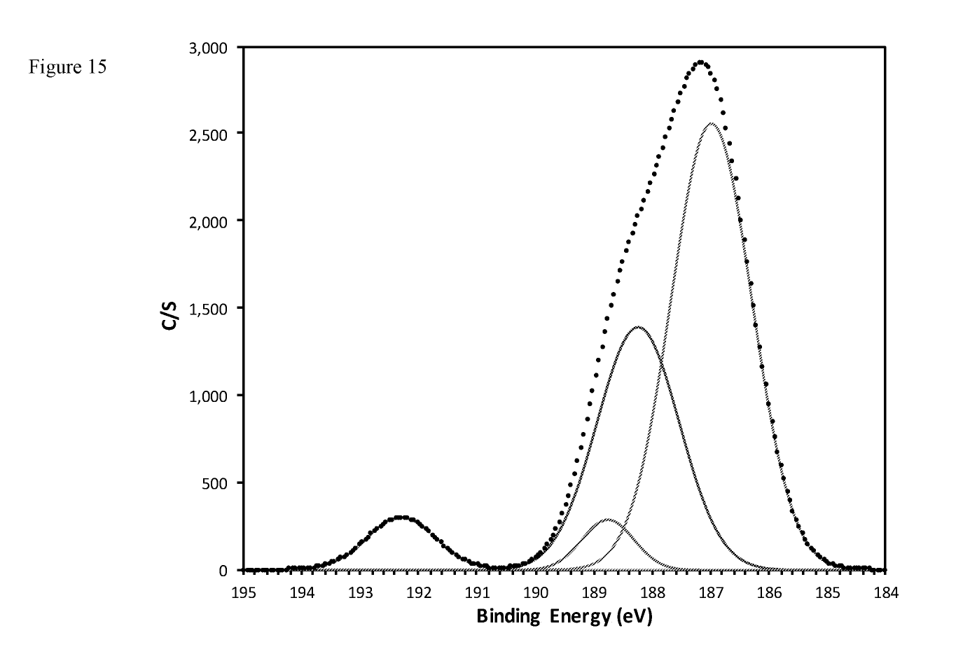

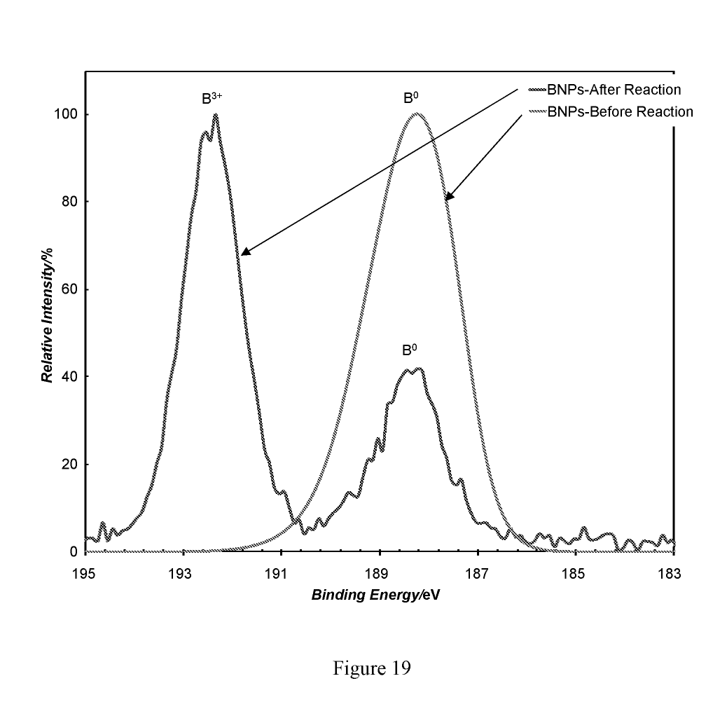

Exposing the BNPs to air for 1 hour at room temperature, we expected to see evidence of the B³⁺ oxidation state. Instead, the main peak broadened, intensity decreased and another suboxide at a higher binding energy (190.4 eV) started to appear. Further air exposure of the BNPs for 1 month still did not show evidence of B³⁺ associated with formation of boron oxide. However, the 4 month air exposed sample showed a peak at 193.5 eV associated with B³⁺ and other suboxides in the main peak. According to the peak areas calculated for each component, presented in Table 1, we conclude that increasing the air exposure time leads to conversion of more elemental boron to boron suboxides on the surface. Thermodynamically boron oxide (B³⁺) formation is favorable (835.96 kJ/mol), but the slow oxidation suggests a kinetic barrier to oxidation at room temperature. This means that the BNPs produced in our reactor system are reasonably air stable at room temperature for at least a month. Even the 4-month air exposed BNP sample had less boron oxide and suboxides than the commercially available boron, which is surprising given the much larger surface area available for surface oxidation of the BNPs. Nonetheless, this relatively good air stability is advantageous in applications. Quantitative analysis results for the surface atomic composition of the samples are presented in Table 2 including C 1s, which includes a contribution from the carbon-based double-sided tape used to mount the powder on the sample holder. The atomic composition of the samples also implies that air exposure increases oxygen content and decreases elemental boron in the sample, yet the oxygen content remains lower than that of the commercially available boron powder. It is important to note that XPS is only sensitive to the top ˜8-10 nm of the sample. Thus it may nearly sample the entirely of the BNPs, but only samples a thin surface layer of the commercial powder. Even for the BNPs, because the primary particles are aggregated, XPS will selectively analyze primary particles near the outer perimeter of aggregates, rather than those near the center of aggregates. Additional XPS spectra are provided in FIG. 15. FIG. 19 shows XPS survey spectra of BNPs after and before hydrogen generation reactions.

TABLE 1
Binding energies and their populations (% area) of the as synthesized and air exposed BNPs
from XPS. The same data for commercial boron particles are presented for comparison.

| Air Exposure Duration | | | | | | | | Commercial | |
|---|---|---|---|---|---|---|---|---|---|
| 0 | | 1 Hour | | 1 Month | | 4 Month | | Boron | |
| Binding | % | Binding | % | Binding | % | Binding | % | Binding | % |
| Energy [eV] | Area | Energy [eV] | Area | Energy [eV] | Area | Energy [eV] | Area | Energy [eV] | Area |
| 188.0 | 81 | 188.3 | 79 | 188.2 | 77 | 188.0 | 68 | 186.9 | 62 |
| 189.2 | 19 | 189.5 | 14 | 189.4 | 15 | 189.1 | 23 | 188.1 | 26 |
| — | — | 190.4 | 7 | 190.4 | 8 | 190.4 | 5 | 188.6 | 5 |
| — | — | — | — | — | — | 193.5 | 4 | 192.2 | 7 |

TABLE 2
Surface atomic composition of the as synthesized and air
exposed BNPs from XPS. The same data for commercial
boron particles are presented for comparison.

| | Air Exposure Duration | | | | |
|---|---|---|---|---|---|
| | | 1 | 1 | 4 | Commercial |
| | 0 | Hour | Month | Month | Boron |
| B1s | 79.9 | 76.7 | 70.5 | 61.5 | 61.3 |
| C1s | 10.9 | 13.7 | 17.2 | 23.5 | 9.9 |
| O1s | 9.2 | 9.6 | 12.3 | 15.0 | 28.9 |

Boron Hydrolysis.

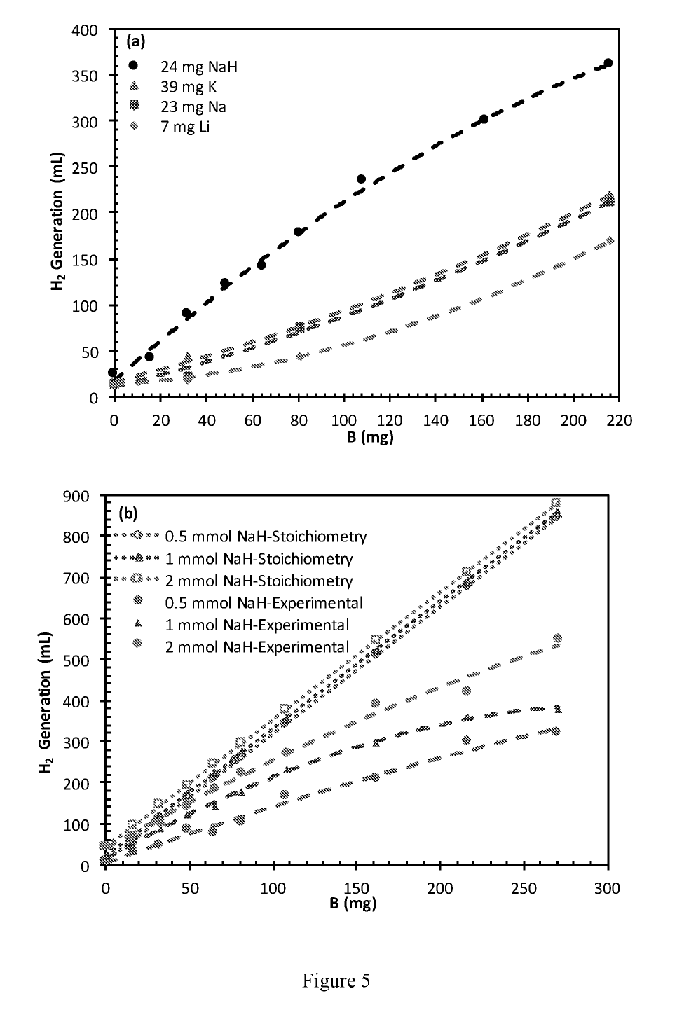

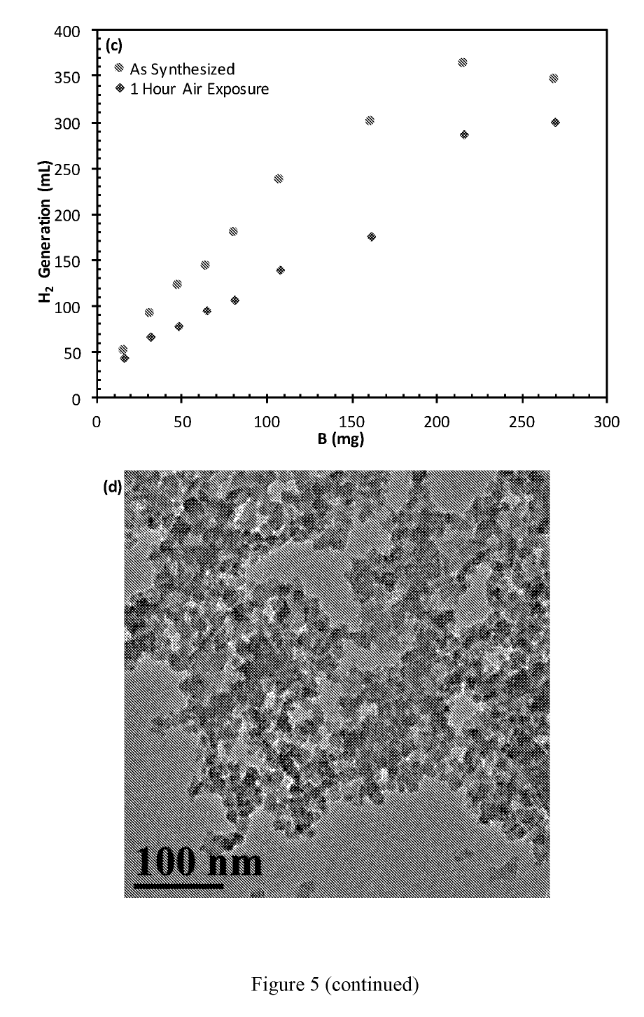

Alkali metals, metal hydrides and metal hydroxides including Li, Na, K, LiH, NaH, MgH₂, LiOH, NaOH and KOH were tested as activators for the reaction of BNPs with water, but only Li, Na, K, and NaH activated the reaction. For those materials, the hydrogen generation was effectively instantaneous, reaching completion within ˜1 s of water injection into the reaction vessel. The large exothermicity of the reactions makes the process effectively autocatalytic. FIG. 5(a) shows hydrogen generation versus BNP mass using 1 mmol of activator and 2 mL water. Among these activators, NaH clearly produces the highest hydrogen generation for a fixed amount of BNPs. The following reactions are the most probable overall reactions during hydrogen generation:

B_{(S)}+3H₂O_{(L)}→B(OH)_{3(aq)}+1.5H_{2(g)}K_{298.15}=3.21×10⁴² (1)

B_{(S)}+0.5H₂O_{(L)}→B₂O_{3(S)}+1.5H_{2(g)}K_{298.15}=1.69×10¹² (2)

NaH_{(S)}+H₂O_{(L)}→NaOH_{(aq)}+H_{2(g)}K_{298.15}=1.27×10¹³ (3)

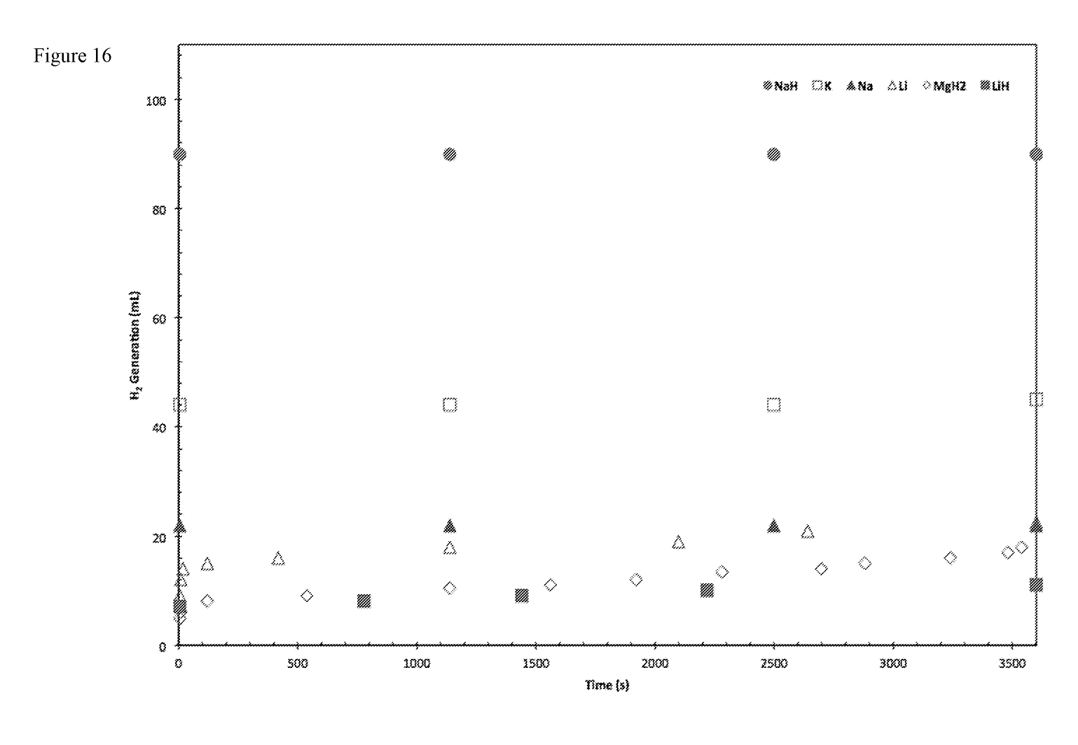

Boron hydrolysis and boron combustion reactions behave similarly in terms of reaction rates and chemical components. FIG. 16 also presents hydrogen generation versus time for hydrolysis of 32 mg BNPs mixed with 1 mmol of each activator. FIG. 5(b) shows hydrogen generation from water using different amounts of BNPs activated by NaH. In this FIG. 0.5, 1 and 2 mmol of NaH were used as an activator. Theoretical amounts of hydrogen generation from the stoichiometry of reactions 1 and 2 are also presented for comparison. Increasing the amount of NaH increased the hydrogen generation for a given amount of BNPs, but the total hydrogen generated remained below the stoichiometric quantity that would correspond to complete oxidation of boron by water. The value reported for BNP hydrolysis is the sum of hydrogen generation from NaH and BNP hydrolysis. Hydrogen generation at zero amount of BNPs represents NaH hydrolysis. The figure clearly shows that increasing the amount of BNPs increases the hydrogen generated at a constant amount of activator, and that the hydrogen generated from boron oxidation can vastly exceed that generated by the activator alone. This shows that NaH participates in an activating role, not as a stoichiometric reagent in the process. However, total hydrogen production from boron is not unlimited, because the amount of DI water and activator added to the system is constant. For the highest quantities of BNPs used (270 mg) approximately 1.4 mL of water would be required for reactions (1) and (3) to go to completion, so water remains in excess but the excess water may not be sufficient to fully wet all of the boron powder. While the volume of the BNP depends on details of its loading and packing into the reactor, for the largest boron quantities used here, the total volume of void space between the dry particles far exceeds 2 mL. For comparison, three boron hydrolysis experiments have been conducted using 100 mg BNPs mixed with 1 mmol NaH and 0.5, 1, and 2 mL DI water injected to the reaction vessel. In the case where 0.5 mL water was added, only 90 mL hydrogen was generated. However, in cases where we added 1 and 2 mL water, equal amounts of ˜235 mL hydrogen generated. Depending upon the details of powder loading, the minimum amount of needed water to fully wet the powder will vary. Scatter in the data shown in these plots has simple practical origins; accurately weighing and consistently loading the BNPs into the hydrolysis reactor in the dry environment of the glove box is challenging. A small fraction of the BNPs typically adheres to the sides of the hydrolysis reactor and may not participate in the reaction.

The most obvious means by which the alkali metals and metal hydrides can activate boron hydrolysis is through local heating. The enthalpies of reaction for hydrolysis of NaH, K, Na and Li at room temperature are −84, −282, −283 and −342 kJ/mol respectively. Thus, based on the total heat release, one would expect Li to be the most effective, and NaH the least effective in thermally initiating the boron hydrolysis. However, hydrolysis of NaH is much faster than hydrolysis of these other materials, and thus the local heating rate is likely to be highest using NaH. To directly investigate the hydrolysis process, we used a custom-designed glass vessel that allowed monitoring of the reaction process using a high-speed camera. High-speed video captured at 21,000 fps and 47.6 μs time resolution revealed details of the hydrolysis process when water was rapidly added to a dry powder of NaH and BNPs. In one case, the glass vessel contained air, and the hydrogen produced by chemical water splitting ignited. Once the oxygen was consumed, hydrogen generation and steam formation continued. In a second video, the glass vessel was sealed so that no ignition occurred. In both cases, the process was complete in less than 1 s (s=seconds). To more clearly observe the gas formation, a small lump of BNPs coated with NaH was dropped into a cuvette of water. Bubble formation resulted.

Surface oxidation of the BNPs prior to their hydrolysis reduces their hydrogen generation potential. The surface layer of oxide, suboxide, and/or hydroxide inhibits boron hydrolysis. This same issue affects use of BNPs in combustion and propulsion applications. Therefore, preparing and storing BNPs in an air- and moisture-free environment is preferable, and is crucial in some applications. FIG. 5(c) compares results of hydrolysis of the as synthesized and 1 hour air exposed BNPs mixed with 1 mmol NaH. As can be seen from the figure, the air exposed BNPs generate less hydrogen compared to the same amount of unexposed BNPs. The boron suboxide layers impede boron hydrolysis and decrease the total hydrogen generation by 13-42%, depending on the amount of BNPs used. Therefore, formation of the oxide layer (boron oxide, hydroxides, or suboxides) and diffusion of water through the oxide layer limit the complete BNP hydrolysis reactions. The by-product of BNP hydrolysis in this system is presumably a form of boric acid, which contains a small amount of sodium from the NaH activator. A TEM image of the by-product is shown in FIG. 5(d). The byproduct particles are deformed and more densely aggregated than the as prepared BNPs. Some of the byproduct may be water soluble, but would precipitate upon drying.

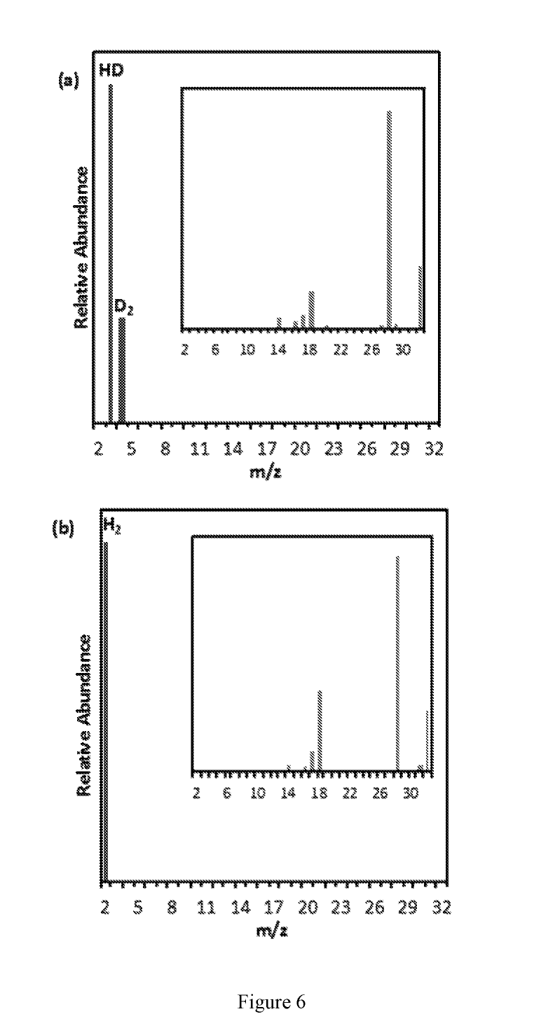

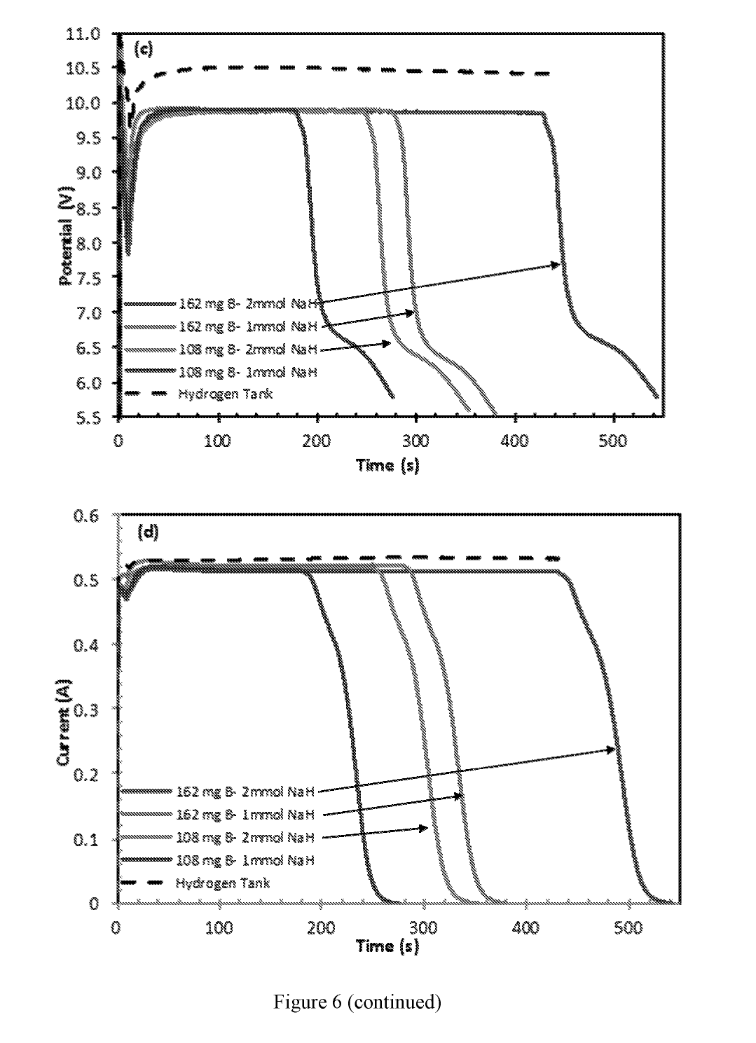

Mass spectra of the gaseous (hydrogen) product from BNPs activated by NaH using D₂O (99.8 at. % D) and H₂O are presented in FIG. 6(a-b), respectively. After background subtraction, the mass spectra show that the gaseous product consists mainly of H₂, HD, and D₂. The substantial quantity of HD produced by hydrolysis using D₂O strongly suggests that hydrogen remaining on the surface of the BNPs from their synthesis, as evident in FTIR, contributes to H₂ production during hydrolysis. The HD production cannot be accounted for by the small quantity of H available from the NaH activator.

Direct application of hydrogen generated by BNP hydrolysis was demonstrated using a small 20-membrane stack PEM fuel cell. The hydrogen from the hydrolysis reactor was sent through the fuel cell at a constant flow rate of 50 sccm controlled by a mass flow controller. The 4 conditions selected for this demonstration were 108 mg BNPs-1 mmol NaH, 108 mg BNPs-2 mmol NaH, 162 mg BNPs-1 mmol NaH and 162 mg BNPs-2 mmol NaH. For comparison, pure hydrogen from a compressed gas cylinder was delivered to the fuel cell at the same flow rate. As depicted in FIGS. 6(c-d), the potential and current data collected from the fuel cell for boron hydrolysis are very close to those achieved using compressed hydrogen, which indicates that the gaseous product from boron hydrolysis is hydrogen and any possible byproducts such as traces of boric acid do not immediately affect the fuel cell operation.

Energies delivered from the fuel cell and gravimetric capacity for each condition are presented in Table 3. In our previous study on hydrogen generation from silicon nanoparticles (SiNPs), the energy delivered from 100 mg SiNPs activated by an aqueous solution of 1600 mg KOH in 2 mL water and 200 mg SiNPs activated by an aqueous solution of 3200 mg KOH in 2 mL water are 400 and 600 J respectively. The gravimetric capacity for these two conditions are 9.804×10⁻³ and 4.902×10⁻³ kWh/kg material respectively (when the mass of KOH is included). Even excluding the mass of KOH, the gravimetric capacity of the SiNPs were just 1.11 and 0.83 kWh/kg SiNPs. Comparing these values with the energy and gravimetric capacity delivered from boron hydrolysis using BNPs activated by NaH surprisingly shows that the BNPs have substantially higher performance than SiNPs. For further comparison, boron hydrolysis experiments were conducted with commercial boron using the same catalysts. No hydrogen or other gaseous product was detected in any of the experiments. Therefore, the nanoscale size and high surface area of the BNPs are essential to the high activity observed here. Production of BNPs with high surface area using laser pyrolysis opens the possibility of on-demand hydrogen production from boron hydrolysis.

TABLE 3
Energy and gravimetric capacity measurement from the TDM 20
membrane stack fuel cell running by the hydrogen generated by
boron hydrolysis (mixtures of BNP and NaH).

| | | | Gravimetric Capacity | |
|---|---|---|---|---|
| | Energy [J] | | [kWh/kg] | |
| | 108 mg | 162 mg | 108 mg | 162 mg |
| | BNPs | BNPs | BNPs | BNPs |
| 1 mmol | 1024 | 1618 | 2.155 | 2.416 |
| NaH | | | | |
| 2 mmol | 1444 | 2371 | 2.571 | 3.136 |
| NaH | | | | |

We have synthesized BNPs in a single step gas phase process via CO₂ laser-induced pyrolysis of mixtures of B₂H₆ and SF₆. The prepared BNPs are amorphous, oxide free, have high purity and are stably dispersed in water and alcohols. Upon air exposure, boron suboxides start to form on the surface, but complete oxidation of boron (to B³⁺) was not evident for at least a month, which shows surprisingly good air stability of BNPs at room temperature. Unlike commercial boron, the BNPs can split water and generate hydrogen gas at a very high rate using alkali metals and NaH as an activator under conditions where water is a liquid—for example, at room temperature. The high purity, small size, and high surface area per volume of the BNPs is the main reason for this phenomenon. Furthermore, one can safely store BNPs because of their high ignition temperature, even in oxygen rich environments. The high gravimetric hydrogen generation capacity of BNP—NaH mixtures takes us closer to the DOE's target on onboard hydrogen storage for light-duty fuel cell vehicles (1.8 kWh/kg system for 2020).

Instrument Information. Size and morphology of the synthesized particles were characterized by transmission electron microscopy (TEM, JEOL model 2010). The TEM grid was 400-mesh copper with a carbon support film. Grids were prepared for imaging by dispersing product particles in isopropyl alcohol, dropping the dispersion onto the grid and allowing it to dry in the glove box. A NanoSight LM10 Nanoparticle Tracking Analysis system characterized the size distribution of the aggregates in solution. Surface morphology and composition were characterized by SEM and EDS using an AURIGA CrossBeam® Workstation (FIB-SEM) from Carl Zeiss SMT with an Oxford Instruments X-Max® 20 mm² EDS detector and INCA® software for elemental composition determination. Wide-angle powder X-Ray diffraction (XRD, Rigaku Ultima IV X-Ray Diffractometer) and selected-area electron diffraction (SAED, JEOL model 2010) were used to characterize the crystallinity and crystal phase of the particles. Specific surface area was measured using a Tristar 3020 surface area analyzer from Micromeritics. Thermogravimetric analysis was done using a NETZSCH TG209 F1. X-ray photoelectron spectroscopy using a VersaProbe 5000 by PHI Electronics, INC was employed to characterize the electronic state of elements within the material and for elemental composition. All analyses were completed using a monochromated Al k-alpha X-ray source (1486 eV) and main chamber pressures were 6.8×10⁻⁹ Torr or less. BRUKER VERTEX 70 FT-IR spectrometers used for IR spectroscopy. A HP model 8452A UV-vis photodiode array spectrophotometer was used to acquire the UV-vis spectra. A ThermoFinnigan MAT95XL high resolution magnetic sector mass spectrometer was used to analyse the gases generated by boron hydrolysis. A small fuel cell from TDM fuel cell technology with 20 stack polymer electrolyte membrane used to demonstrate the electricity generation using hydrogen from boron hydrolysis. Pure hydrogen from a compressed gas cylinder was used to activate the fuel cell catalysts prior to each experiment. High-speed videos were recorded using a Phantom V7.3 color camera from Vision Research.

NanoSight nanoparticle tracking analysis. The minimum size of the particles for this analysis is greater than 10 nm, because they must scatter enough light for the instrument to detect their Brownian motion. Because the average size of our boron nanoparticles is ˜15 nm and they are mostly aggregated, size distribution analysis using the NanoSight system gave us a good approximation of the hydrodynamic diameter of the aggregates. For a dilute dispersion of as synthesized boron nanoparticles in isopropyl alcohol prepared by sonicating the solution for 5 minutes, the NanoSight gave a mean diameter of 203 nm and a concentration of 1.5×10⁹ particles per mL. After 3 hours of bath sonication of the same sample, the mean diameter decreased to 108 nm and the concentration correspondingly increased to 2.2×10⁹ particles per mL. The graph in FIG. 7 shows the concentration of the particles versus particle size after 3 hours of sonication. As presented in Table 4, 3 hours sonication broke up some of the aggregates. However, further sonication did not change the size of aggregates significantly.

TABLE 4
Results from Nanosight tracking analysis for the as prepared and 3
hour sonicated BNPs.

| | | After 3 |
|---|---|---|
| | As | Hours |
| | Prepared | Sonication |
| Valid Tracks | 3670 | 4885 |
| Mode [nm] | 203 | 84 |
| Mean [nm] | 203 | 108 |
| SD [nm] | 94 | 57 |
| Concentration | 14.93 | 22.27 |
| [E8 Particles/mL] | | |

Surface Morphology and Composition. FIG. 8 shows the surface morphology of the BNPs using SEM and the elemental composition using EDX. An important limitation of SEM analysis was the exposure of the sample to air prior to analysis. The elemental oxygen percentage in the EDX analysis includes possible oxidation on the surface of the particles as well as adsorbed water.

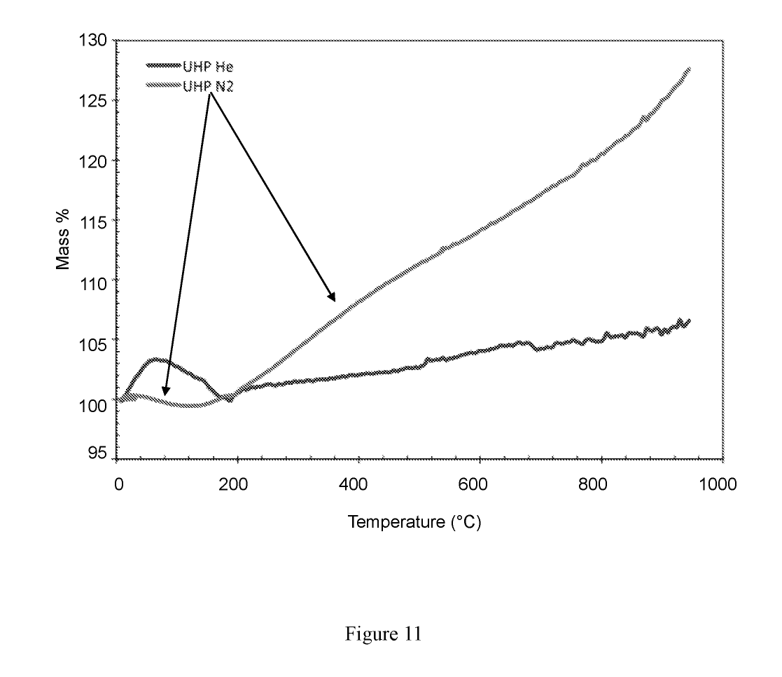

Thermogravimetric Analysis of BNPs. FIG. 10(a) shows the TGA of the BNPs with different heating rates of 1, 5, 10, 15, 16, 17, 18, 20, 40 and 50 K/min under 50% O₂-50% Ar (v/v) from room temperature to 1000° C. followed by 1 hour at 1000° C. Derivative thermogravimetric curves are presented in FIG. 10(b). These figures imply that faster heating rates lead to sharper weight gain at the onset temperature of oxidation reaction. Therefore, weight gain is dependent on heating rate. FIG. 11 shows the TGA of as synthesized BNPs at 10 K/min heating rate under UHP He and N₂. According to this analysis, some oxidation still happens under UHP N₂ probably because there is enough oxygen in the carrier gas. However, much less weight gain occurred in TGA under UHP He.

FIG. 12 shows the TGA of both as synthesized BNPs and commercial boron with the heating rate of 10 K/min under 50% O₂-50% Ar (v/v) from room temperature to 1000° C. followed by 1 hour at 1000° C. The onset of oxidation for the commercial boron is at ˜726° C. where as for the as synthesized BNPs it is ˜497° C., a ˜230° C. difference. Formation of different boron suboxides in commercial boron, which melt at a higher temperature, is a possible reason for this difference. Table 5 provides thermodynamic properties of reactants and products.

TABLE 5
Thermodynamic properties of reactants and products.

| | ΔH_{f}° | ΔG_{f}° | |
|---|---|---|---|
| Material | [kJ/mol] | [kJ/mol] | ΔS_{f}° [kJ/mol] |
| B₂O₃ | −835.96 | −825.34 | −35.63 |
| B(OH)₃ | −992.23 | −928.37 | −214.17 |
| H₂O | −241.83 | −228.58 | −44.42 |
| NaH | 124.27 | 102.92 | 71.59 |
| NaOH | −197.76 | −200.46 | 9.08 |
| B₂H₆ | 41.00 | 91.85 | −170.54 |

Yaws, C. L. Yaws' Handbook of Thermodynamic Properties for Hydrocarbons and Chemicals. Knovel.

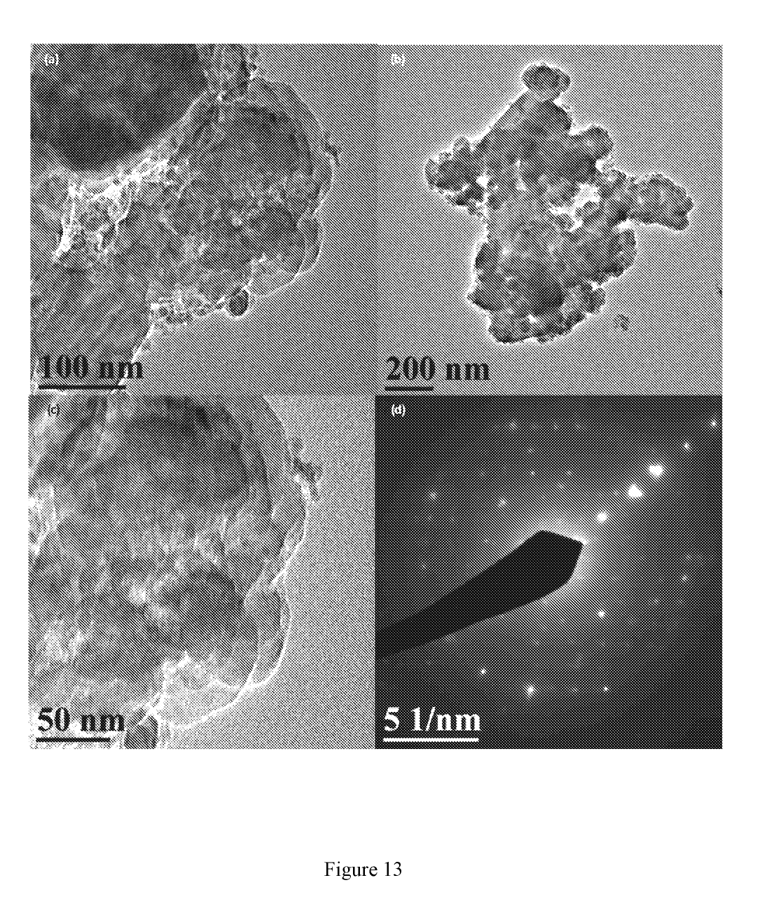

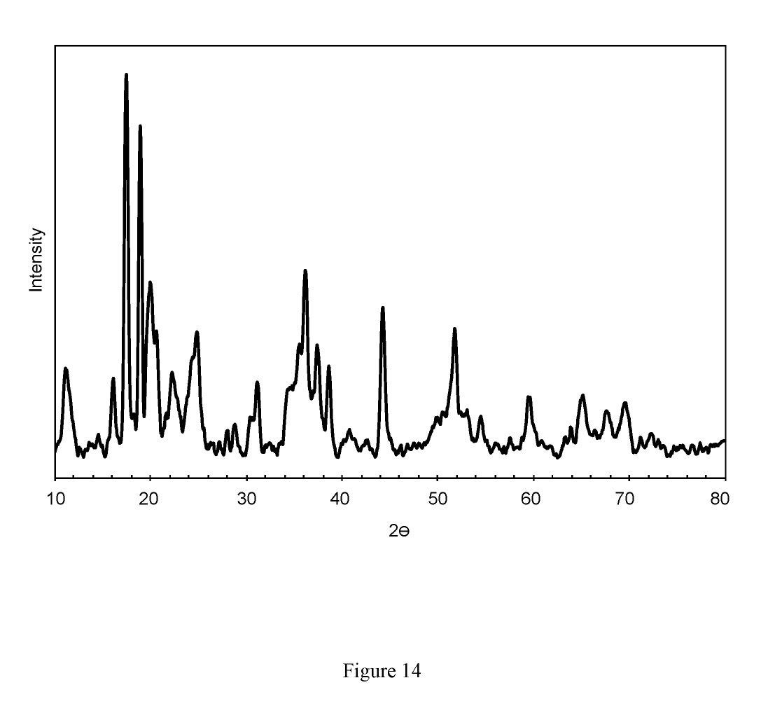

Commercial Boron. Amorphous boron powder (95-97%) was purchased from Strem Chemicals. They claimed that the size was 0.4-0.7 microns, which is close to what we found in TEM. The purchased boron does not have a specific shape or morphology as can be seen in the following TEM images. Although this material was nominally specified as amorphous, SAED showed evidence of crystallinity. XRD also showed sharp peaks in the pattern, but these were not readily indexed to any common boron or boron oxide/suboxide/hydroxide phase. XPS analysis showed that the commercially available boron was somewhat surface oxidized, showing significant evidence of the B³⁺ oxidation state as well as sub-oxides. FIG. 13 shows TEM images of a commercial boron (a-c) and SAED of commercial boron (d). FIG. 14 shows powder XRD pattern of a commercial boron. We didn't observe any gaseous product associated with this boron in the hydrogen generation experiments. The amount of hydrogen generation observed was only associated with NaH.

### Example 2

This example provides a description of methods of making and characterizing boron nanoparticles and using boron nanoparticles to generate hydrogen.

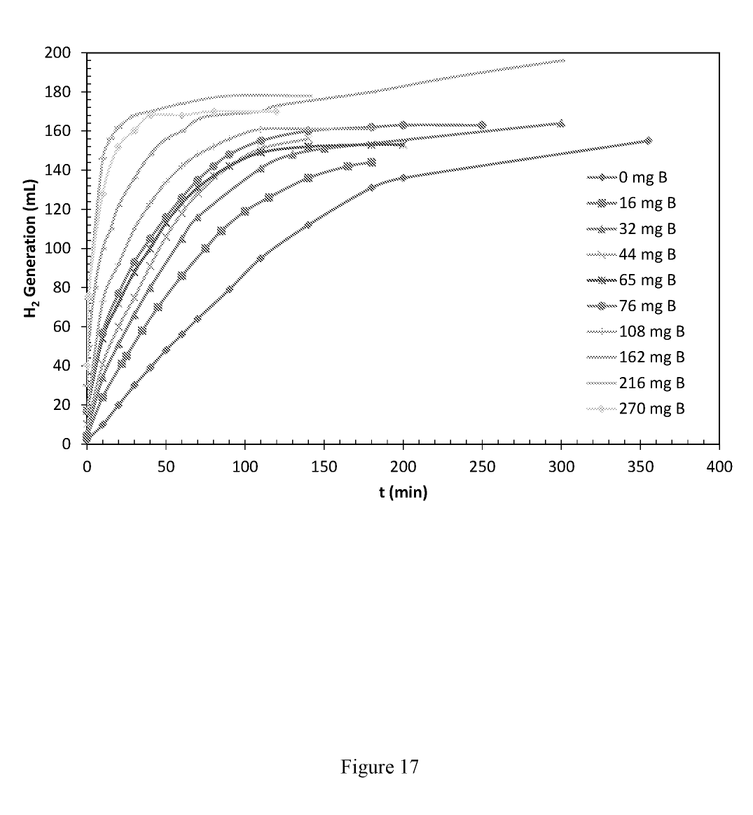

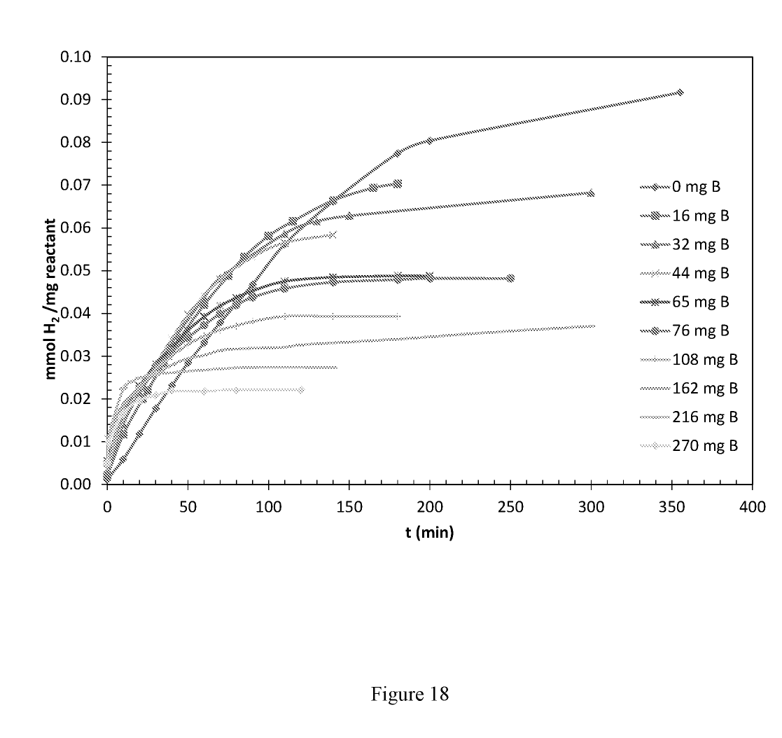

FIGS. 17 and 18 show hydrogen generation using various amounts of boron nanoparticles. The boron nanoparticles were prepared as described in Example 1. The hydrogen generation experiments were carried out as described in Example 1. In this case, hydrogen generation was observed over time, rather than occurring instantaneously.

All the experiments were carried out in an inert atmosphere (N₂) in a custom-designed cylindrical vessel (≈50 mL internal volume). The BNPs (0, 1.5, 3, 4, 6, 7, 10, 15, 20 and 25 mmol) and sodium borohydride (2 mmol) were weighed in a glovebox, added to the vessel, and connected to an inverted graduated cylinder of water to measure the volume of gas generated. Two mL of DI water (or deuterated water) was used in each experiment. Hydrogen generation versus time were measured for each experiment and plotted. The overlay plot indicates that boron nanoparticles act as a catalyst for sodium borohydride hydrolysis because hydrogen generation reaches almost the same plateau for each experiment. However, when we used boron nanoparticles, hydrogen generates much faster compared to the case where no boron nanoparticles were added.

The preceding description provides specific examples of the present disclosure. Those skilled in the art will recognize that routine modifications to these examples can be made which are intended to be within the scope of the disclosure.

1. A method of generating hydrogen gas comprising contacting boron nanoparticles, a liquid comprising water, and an activator selected from alkali metals, metal hydrides, and combinations thereof,
wherein the hydrogen gas is generated.

2. The method of generating hydrogen gas of claim 1, wherein the activator is selected from the group consisting of lithium metal, sodium metal, potassium metal, lithium hydride, sodium hydride, and combinations thereof.

3. The method of generating hydrogen of claim 1, wherein the activator is lithium hydride, sodium hydride, or a combination thereof.

4. The method of generating hydrogen of claim 1, wherein the activator is lithium metal, sodium metal, potassium metal, or a combination thereof.

5. The method of generating hydrogen of claim 1, wherein the nanoparticles are hydrogen-containing boron nanoparticles.

6. The method of generating hydrogen of claim 1, wherein the boron nanoparticles contain less than 5% of elements other than boron and hydrogen.

7. The method of generating hydrogen of claim 1, wherein the boron nanoparticles have a size of 1 to 15 nanometers (nm).

8. The method of generating hydrogen of claim 1, wherein the liquid further comprises one or more additional liquids selected from the group consisting of methanol, ethanol, isopropyl alcohol, propanol, butanol, pentanol, hexanol, ethylene glycol, propylene glycol, and 1,4-butanediol.

9. The method of generating hydrogen of claim 1, wherein hydrogen is generated at temperatures and pressures at which water is a liquid.

10. A method of making boron nanoparticles comprising irradiating a mixture of a boron precursor and photosensitizer in a sheath gas with electromagnetic radiation comprising one or more wavelength that is absorbed by the photosensitizer such that the boron precursor is pyrolyzed and the boron nanoparticles are formed.

11. The method of claim 10, wherein the electromagnetic radiation is provided by an infrared laser.

12. The method of claim 10, wherein the electromagnetic radiation comprises a wavelength of 10.6 microns.

13. The method of claim 10, wherein the photosensitizer is sulfur hexafluoride (SF₆).

14. The method of claim 10, wherein the photosensitizer is silicon tetrafluoride (SiF₄).

15. The method of claim 10, wherein the boron precursor is a boron-hydride precursor.

16. The method of claim 15, wherein the boron-hydride precursor is diborane.

17. The method of claim 10, wherein the boron precursor is a boron-halide precursor.

18. The method of claim 10, wherein the boron precursor is present in hydrogen gas.

19. The method of claim 10, wherein the sheath gas is hydrogen.

20. The method of claim 10, wherein the method further comprises collecting the boron nanoparticles.

21. The method of claim 20, wherein the boron nanoparticles are collected on a filter.

22. The method of claim 20, wherein the boron nanoparticles are collected by thermophoretic deposition.

23. The method of claim 20, wherein the boron nanoparticles are collected in a liquid solution by contacting the irradiated mixture with the liquid.

24. A hydrogen-generating device comprising boron nanoparticles, one or more activator, and water, wherein the device is configured such that the boron nanoparticles, one or more activator, and water are combined and hydrogen is generated.

25. The device of claim 24, wherein the boron nanoparticles and/or the one or more activator is/are disposed in a cartridge.
